(19) United States
(12) Patent Application Publication
(10) Pub. No.: US 2026/0186383 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventor: Jiahui Li, Changzhou (CN)

(21) Appl. No.: 19/307,023

(22) Filed: Aug. 21, 2025

Related U.S. Application Data
(63) Continuation of application No. PCT/CN2024/144549, filed on Dec. 31, 2024.

(51) Int. Cl. G03B 17/17; G02B 9/60

(52) U.S. Cl. CPC G03B 17/17; G02B 9/60

(57) ABSTRACT

A camera optical lens is provided, including, from an object side to an image side in sequence, a first prism, a first lens, a second lens, a third lens, a fourth lens, and a fifth lens. The camera optical lens satisfies: 3.99≤fA/IH≤4.80, Rp1/Rp2≤0.80, 1.40≤(R1+R2)/(R1-R2)≤5.80, and 0.16≤d5/d7≤1.80, fA and IH respectively represent a focal length and an image height of the camera optical lens, Rp1 represents curvature radius of the object side surface of the first prism, Rp2 represents curvature radius of the image side surface of the first prism, R1 represents curvature radius of an object side surface of the first lens, R2 represents curvature radius of an image side surface of the first lens, d5 represents an on-axis thickness of the third lens, and d7 represents an on-axis thickness of the fourth lens.

### CROSS REFERENCE TO RELATED APPLICATIONS

The present application is a continuation of PCT Patent Application No. PCT/CN2024/144549, entitled “CAMERA OPTICAL LENS,” filed on Dec. 31, 2024, which is incorporated herein by reference in its entirety.

### TECHNICAL FIELD

The present disclosure relates to the field of optical lens, and in particular to a camera optical lens applicable to handheld terminal devices such as smart phones and digital cameras, and to camera devices such as monitors and PC lenses.

### BACKGROUND

With the emergence of smart devices in recent years, the demand for miniature camera optical lenses is increasing day by day, but the pixel size of the photosensitive devices is shrinking, coupled with the current development trend of electronic products being that their functions should be better and their shape should be thin and small, miniature camera optical lens with good imaging quality therefor has become a mainstream in the market. In order to obtain good imaging quality, a multi-lenses structure is usually adopted. The internal-focusing camera lenses are gradually developed and applied in mobile phone cameras due to their high stability, fast zoom, good cleanliness, and ability to overcome the wear and tear of external-focusing camera lenses.

In addition, telephoto cameras can meet the needs of consumers to capture specific targets. However, traditional telephoto cameras have an excessive total track length, not meeting the design requirements of lightweight of smartphones. In contrast, the periscope telephoto cameras can significantly shorten the total track length of the camera optical lens while meeting the requirements of telephoto design, but the optical performance of existing periscope telephoto camera optical lenses still cannot meet the requirements.

### SUMMARY

In order to address the above problems, the present disclosure is intended to provide a camera optical lens that can meet the design requirements of long focal lengths, miniaturization, and large apertures, while having good optical performance.

To this end, the present disclosure provide a camera optical lens, including, from an object side to an image side in sequence, a first prism with a positive refractive power, a first lens with a negative refractive power, a second lens with a positive refractive power, a third lens with a negative refractive power, a fourth lens with a positive refractive power, and a fifth lens.

The first lens and the second lens form a first group, and the third lens, the fourth lens, and the fifth lens form a second group that is movable and adjustable along an optical axis of the camera optical lens, allowing the camera optical lens switchable between a first state and a second state, and the camera optical lens has a maximum focal length in the first state and has a minimum focal length in the second state.

A reflective surface is provided between an object side surface of the first prism and an image side surface of the first prism.

The camera optical lens satisfies the following conditions:

$$3.99 \leq fA / IH \leq 4.8 ;$$

$$Rp 1 / Rp 2 \leq 0.8 ;$$

$$1.4 \leq ( R 1 + R 2 ) / ( R 1 - R 2 ) \leq 5.8 ; and$$

$$0.16 \leq d 5 / d 7 \leq 1.8 ;$$

where fA represents a focal length of the camera optical lens in the first state, IH represents an image height of 1.0H of the camera optical lens, Rp1 represents a curvature radius of the object side surface of the first prism, Rp2 represents a curvature radius of the image side surface of the first prism, R1 represents a curvature radius of an object side surface of the first lens, R2 represents a curvature radius of an image side surface of the first lens, d5 represents an on-axis thickness of the third lens, and d7 represents an on-axis thickness of the fourth lens.

As an improvement, the camera optical lens further satisfies the following condition: 3.99≤fA/IH≤4.60.

As an improvement, the camera optical lens further satisfies the following condition: 0.25≤d1/d3≤1.00, where d1 represents an on-axis thickness of the first lens, and d3 represents an on-axis thickness of the second lens.

As an improvement, the camera optical lens further satisfies the following conditions: 1.01≤fp1/fA≤10.31, and 0.320≤dp1/TTL≤0.421, where fp1 represents a focal length of the first prism, dp1 represents a sum of an on-axis distance between the object side surface of the first prism and the reflective surface and an on-axis distance between the reflective surface and the image side surface of the first prism, and TTL represents a total track length of the camera optical lens.

As an improvement, an object side surface of the first lens is convex in a paraxial region, and an image side surface of the first lens is concave in the paraxial region. The camera optical lens further satisfies the following conditions: −2.02≤f1/fA≤−0.62, and 0.024≤d1/TTL≤0.069, where f1 represents a focal length of the first lens, d1 represents an on-axis thickness of the first lens, and TTL represents a total track length of the camera optical lens.

As an improvement, an object side surface of the second lens is convex in a paraxial region, and an image side surface of the second lens is concave in the paraxial region. The camera optical lens further satisfies the following conditions: 0.32≤f2/fA≤0.49, −0.28≤(R3+R4)/(R3−R4)≤0.03, and 0.056≤d3/TTL≤0.089, where f2 represents a focal length of the second lens, R3 represents a curvature radius of the object side surface of the second lens, R4 represents a curvature radius of the image side surface of the second lens, d3 represents an on-axis thickness of the second lens, and TTL represents a total track length of the camera optical lens.

As an improvement, an image side surface of the third lens is concave in a paraxial region, and the camera optical lens further satisfies the following conditions: −2.24≤f3/fA≤-0.46, −0.68≤(R5+R6)/(R5−R6)≤3.38, and 0.011≤ d5/TTL≤0.079, where f3 represents a focal length of the third lens, R5 represents a curvature radius of the object side surface of the third lens, R6 represents a curvature radius of an image side surface of the third lens, and TTL represents a total track length of the camera optical lens.

As an improvement, the camera optical lens further satisfies the following conditions: 0.98≤f4/fA≤6.75, −4.00≤(R7+R8)/(R7−R8)≤18.99, and 0.037≤ d7/TTL≤0.075, where f4 represents a focal length of the fourth lens, R7 represents a curvature radius of the object side surface of the fourth lens, R8 represents a curvature radius of an image side surface of the fourth lens, and TTL represents a total track length of the camera optical lens.

As an improvement, the camera optical lens further satisfies the following conditions: −4381.09≤f5/fA≤64.53, −60.05≤(R9+R10)/(R9-R10) ≤15.60, and 0.018≤d9/TTL≤0.088, where f5 represents a focal length of the fifth lens, R9 represents a curvature radius of the object side surface of the fifth lens, R10 represents a curvature radius of an image side surface of the fifth lens, d9 represents an on-axis thickness of the fifth lens, and TTL represents a total track length of the camera optical lens.

As an improvement, the first prism is made of glass.

The beneficial effects of the present disclosure are: by stipulating a ratio of the focal length to the image height of the camera optical lens, the camera optical lens can have a greater focal length when the image height is fixed, which helps to improve the magnification of the camera optical lens. By grouping the first lens, the second lens, and the third lens into a front group movable for focusing, and grouping the fourth lens and the fifth lens into a back group, the focusing process can be faster and smoother, while the physical length of the lens can be unchanged, which is conducive to allocation of the internal space of the camera optical lens. By stipulating the shapes of the convex surface and the concave surface of the first prism P1 to be within the range according the above-mentioned condition, it is conducive to alleviating a degree of deflection of light passing through the lenses, thereby facilitating smooth propagation of the light. By reasonably controlling the shapes of surfaces of the first lens, it is conducive to lowering sensitivity of the camera optical lens and reducing the formation difficulty, thereby improving yield rate; in addition, it is also conducive to reducing stray light generated by the lens, thereby improving the imaging quality of the camera optical lens. By reasonably allocating the thicknesses of the lenses, it is conducive to reducing the assembly difficulty in the production process, and to improving yield rate; in addition, within the ranges according the above-mentioned conditions, it is conducive to reducing the total track length of the camera optical lens.

### BRIEF DESCRIPTION OF DRAWINGS

For clearer descriptions of the technical solutions in the embodiments of the present disclosure, drawings that are to be referred for description of the embodiments are briefly described hereinafter. Apparently, the drawings described hereinafter merely illustrate some embodiments of the present disclosure. Persons of ordinary skill in the art can derive other drawings based on the drawings described herein without any creative effort.

FIG. 1 is a schematic diagram of a structure of a camera optical lens that is in a first state according to a first embodiment of the present disclosure.

FIG. 2 is a schematic diagram of a lateral color of the camera optical lens shown in FIG. 1.

FIG. 3 is a schematic diagram of a longitudinal aberration of the camera optical lens shown in FIG. 1.

FIG. 4 is a schematic diagram of a field curvature and a distortion of the camera optical lens shown in FIG. 1.

FIG. 5 is a schematic diagram of a structure of a camera optical lens that is in the first state according to a second embodiment of the present disclosure.

FIG. 6 is a schematic diagram of a lateral color of the camera optical lens shown in FIG. 5.

FIG. 7 is a schematic diagram of a longitudinal aberration of the camera optical lens shown in FIG. 5.

FIG. 8 is a schematic diagram of a field curvature and a distortion of the camera optical lens shown in FIG. 5.

FIG. 9 is a schematic diagram of a structure of a camera optical lens that is in the first state according to a third embodiment of the present disclosure.

FIG. 10 is a schematic diagram of a lateral color of the camera optical lens shown in FIG. 9.

FIG. 11 is a schematic diagram of a longitudinal aberration of the camera optical lens shown in FIG. 9.

FIG. 12 is a schematic diagram of a field curvature and a distortion of the camera optical lens shown in FIG. 9.

FIG. 13 is a schematic diagram of a structure of a camera optical lens that is in the first state according to a fourth embodiment of the present disclosure.

FIG. 14 is a schematic diagram of a lateral color of the camera optical lens shown in FIG. 13.

FIG. 15 is a schematic diagram of a longitudinal aberration of the camera optical lens shown in FIG. 13.

FIG. 16 is a schematic diagram of a field curvature and a distortion of the camera optical lens shown in FIG. 13.

FIG. 17 is a schematic diagram of a structure of a camera optical lens that is in the first state according to a fifth embodiment of the present disclosure.

FIG. 18 is a schematic diagram of a lateral color of the camera optical lens shown in FIG. 17.

FIG. 19 is a schematic diagram of a longitudinal aberration of the camera optical lens shown in FIG. 17.

FIG. 20 is a schematic diagram of a field curvature and a distortion of the camera optical lens shown in FIG. 17.

FIG. 21 is a schematic diagram of a structure of a camera optical lens that is in a first state according to a sixth embodiment of the present disclosure.

FIG. 22 is a schematic diagram of a lateral color of the camera optical lens shown in FIG. 21.

FIG. 23 is a schematic diagram of a longitudinal aberration of the camera optical lens shown in FIG. 21.

FIG. 24 is a schematic diagram of a field curvature and a distortion of the camera optical lens shown in FIG. 21.

FIG. 25 is a schematic diagram of a structure of a camera optical lens that is in the first state according to a seventh embodiment of the present disclosure.

FIG. 26 is a schematic diagram of a lateral color of the camera optical lens shown in FIG. 25.

FIG. 27 is a schematic diagram of a longitudinal aberration of the camera optical lens shown in FIG. 25.

FIG. 28 is a schematic diagram of a field curvature and a distortion of the camera optical lens shown in FIG. 25.

FIG. 29 is a schematic diagram of a structure of a camera optical lens that is in the first state according to an eighth embodiment of the present disclosure.

FIG. 30 is a schematic diagram of a lateral color of the camera optical lens shown in FIG. 29.

FIG. 31 is a schematic diagram of a longitudinal aberration of the camera optical lens shown in FIG. 29.

FIG. 32 is a schematic diagram of a field curvature and a distortion of the camera optical lens shown in FIG. 29.

FIG. 33 is a schematic diagram of a structure of a camera optical lens that is in the first state according to a ninth embodiment of the present disclosure.

FIG. 34 is a schematic diagram of a lateral color of the camera optical lens shown in FIG. 33.

FIG. 35 is a schematic diagram of a longitudinal aberration of the camera optical lens shown in FIG. 33.

FIG. 36 is a schematic diagram of a field curvature and a distortion of the camera optical lens shown in FIG. 33.

FIG. 37 is a schematic diagram of a structure of a camera optical lens that is in the first state according to a tenth embodiment of the present disclosure.

FIG. 38 is a schematic diagram of a lateral color of the camera optical lens shown in FIG. 37.

FIG. 39 is a schematic diagram of a longitudinal aberration of the camera optical lens shown in FIG. 37.

FIG. 40 is a schematic diagram of a field curvature and a distortion of the camera optical lens shown in FIG. 37.

FIG. 41 is a schematic diagram of a structure of a camera optical lens that is in the first state according to an eleventh embodiment of the present disclosure.

FIG. 42 is a schematic diagram of a lateral color of the camera optical lens shown in FIG. 41.

FIG. 43 is a schematic diagram of a longitudinal aberration of the camera optical lens shown in FIG. 41.

FIG. 44 is a schematic diagram of a field curvature and a distortion of the camera optical lens shown in FIG. 41.

FIG. 45 is a schematic diagram of a structure of a camera optical lens that is in the first state according to a twelfth embodiment of the present disclosure.

FIG. 46 is a schematic diagram of a lateral color of the camera optical lens shown in FIG. 45.

FIG. 47 is a schematic diagram of a longitudinal aberration of the camera optical lens shown in FIG. 45.

FIG. 48 is a schematic diagram of a field curvature and a distortion of the camera optical lens shown in FIG. 45.

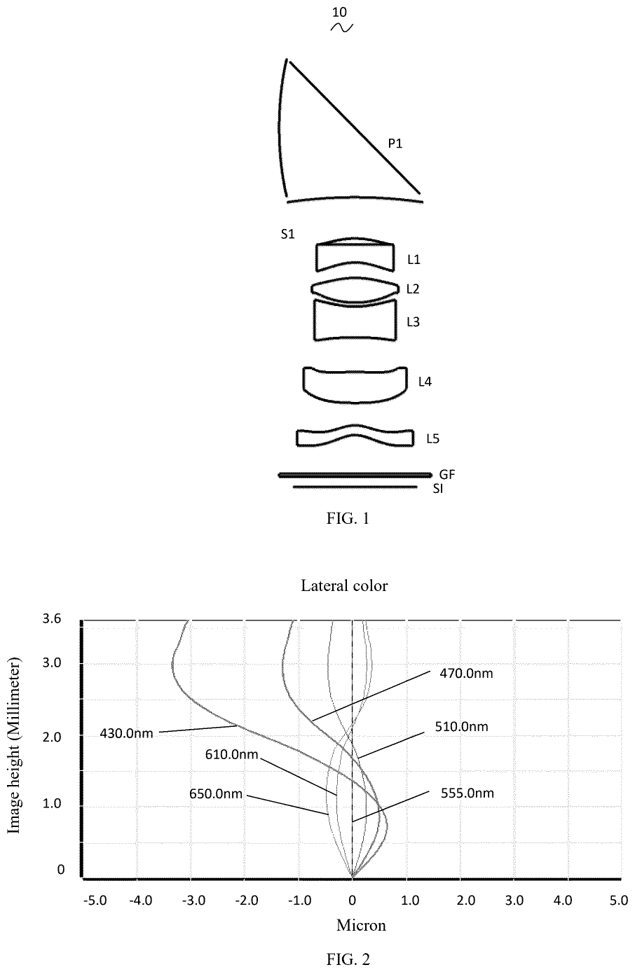

### DETAILED DESCRIPTION OF EMBODIMENTS

To make the objects, technical solutions, and advantages of the present disclosure clearer, embodiments of the present disclosure are described in detail with reference to accompanying drawings in the following. A person of ordinary skill in the art can understand that, in the embodiments of the present disclosure, many technical details are provided to make readers better understand the present disclosure. However, even without these technical details and any changes and modifications based on the following embodiments, technical solutions required to be protected by the present disclosure can be implemented.

Referring to the drawings, the present disclosure provides camera optical lenses 10 to 120. Each of the camera optical lenses 10 to 120 includes, from an object side to an image side in sequence, a first prism P1 with a positive refractive power, a first lens L1 with a negative refractive power, a second lens L2 with a positive refractive power, a third lens L3 with a negative refractive power, a fourth lens L4 with a positive refractive power, and a fifth lens L5.

The first lens and the second lens form a first group, and the third lens, the fourth lens, and the fifth lens form a second group that is movable and adjustable along an optical axis of each of the camera optical lenses 10 to 120, allowing the camera optical lenses 10 to 120 switchable between a first state and a second state, and each of the camera optical lenses 10 to 120 has a maximum focal length in the first state and has a minimum focal length in the second state. For example, the first state may be either a telephoto state or an infinity focus state, and the second state may be either a wide-angle state or a macro state, such as a state in which an object distance is equal to 200 mm. In this way, internal focusing of each of the camera optical lenses 10 to 120 can be achieved based on the movable focusing of the second group. By grouping the first lens L1, the second lens L2, and the third lens L3 into a front group movable for focusing, and grouping the fourth lens L4 and the fifth lens L5 into a back group, the focusing process can be faster and smoother, while the physical length of the lens can be unchanged, which is conducive to allocation of the internal space of the camera optical lens.

Each of the camera optical lenses 10 to 120 satisfies the following condition: 3.99≤fA/IH≤4.80, where fA represents a focal length of the camera optical lenses 10 to 120 in the first state, and IH represents an image height of 1.0H of the camera optical lenses 10 to 120. By stipulating a ratio of the focal length to the image height of the camera optical lenses 10 to 120, the camera optical lenses 10 to 120 can have a greater focal length when the image height is fixed, which helps to improve the system magnification of the camera optical lenses 10 to 120. In some embodiments, each of the camera optical lenses 10 to 120 satisfies the following condition: 3.99≤fA/IH≤4.60.

Each of the camera optical lenses 10 to 120 further satisfies the following condition: Rp1/Rp2≤0.80, where Rp1 represents a curvature radius of the object side surface of the first prism P1, and Rp2 represents a curvature radius of the image side surface of the first prism P1. By stipulating the shapes of the convex surface and the concave surface of the first prism P1 to be within the range according the above-mentioned condition, it is conducive to alleviating a degree of deflection of light passing through the lenses, thereby facilitating smooth propagation of the light.

Each of the camera optical lenses 10 to 120 further satisfies the following condition: 1.40≤(R1+R2)/(R1−R2)≤5.80, where R1 represents a curvature radius of an object side surface of the first lens, and R2 represents a curvature radius of an image side surface of the first lens. By reasonably controlling the shapes of surfaces of the first lens L1, it is conducive to lowering system sensitivity of the camera optical lenses 10 to 120 and reducing the formation difficulty, thereby improving yield rate; in addition, it is also conducive to reducing stray light generated by the lens, thereby improving the imaging quality of the lens.

Each of the camera optical lenses 10 to 120 further satisfies the following condition: 0.16≤d5/d7≤1.80, where d5 represents an on-axis thickness of the third lens L3, and d7 represents an on-axis thickness of the fourth lens L4. By reasonably allocating the thicknesses of the lenses, it is conducive to reducing the assembly difficulty in the production process, and to improving yield rate.

When the above conditions are satisfied, the camera optical lenses 10 to 120 can meet the design requirements of large apertures, long focal lengths, and miniaturization, while having good optical performance. With the characteristics of the camera optical lenses 10 to 120, they are particularly suitable for mobile phone camera lens components and WEB camera lenses composed of camera elements such as CCDs or complementary metal-oxide semiconductor sensors (CMOS sensors) with high pixel.

Based on the above conditions and the functions that can be achieved, characteristics of each lens are illustrated in detail as follows.

An on-axis thickness of the first lens L1 is defined as d1, an on-axis thickness of the second lens L2 is defined as d3, and the camera optical lens satisfies a condition of 0.25≤d1/d3≤1.00. By reasonably allocating the thicknesses of the lenses, it is conducive to reducing the total track lengths of the camera optical lenses, such that the camera optical lenses 10 to 120 can meet the design requirement of miniaturization.

The object side surface of the first prism P1 is convex or planar in a paraxial region, and the image side surface of the first prism P1 is concave or convex or planar in the paraxial region. In some embodiments, the object side surface of the first prism P1 may be also concave.

A focal length of the first prism P1 is defined as fp1, and the camera optical lens satisfies a condition of 1.01≤fp1/fA≤10.31. By reasonably allocating the positive refractive power of the first prism P1, the system can have an excellent imaging quality and a lower sensitivity.

A sum of an on-axis distance between the object side surface of the first prism and the reflective surface and an on-axis distance between the reflective surface and the image side surface of the first prism is defined as dp1, a total track length of each of the camera optical lenses 10 to 120 is defined as TTL, and the camera optical lens satisfies a condition of 0.320≤dp1/TTL≤0.421. Within this range, it is conducive to achieving miniaturization and reasonably controlling the total track lengths of the camera optical lenses 10 to 120.

An object side surface of the first lens L1 is convex in the paraxial region, and an image side surface of the first lens L1 is concave in the paraxial region. The object side surface and the image side surface of the first lens L1 may have other concave or convex shapes.

A focal length of the first lens L1 is defined as f1, and the camera optical lens satisfies a condition of −2.02≤f1/fA≤-0.62. By controlling the negative optical power of the first lens L1 within a reasonable range, it is conducive to correcting the aberration of the optical system.

An on-axis thickness of the first lens L1 is defined as d1, a total track length of each of the camera optical lenses 10 to 120 is defined as TTL, and the camera optical lens satisfies a condition of 0.024≤d1/TTL≤0.069. Within this range, it is conducive to reasonably controlling the total track lengths of the camera optical lenses 10 to 120.

An object side surface of the second lens L2 is convex in the paraxial region, and an image side surface of the second lens L2 is convex in the paraxial region. The object side surface and the image side surface of the second lens L2 may have other concave or convex shapes.

A focal length of the second lens L2 is defined as f2, and the camera optical lens satisfies a condition of 0.32≤f2/fA≤0.49. By reasonably allocating the optical power, it is conducive to correcting the aberration of the optical system, thus the system can have an excellent imaging quality and a lower sensitivity.

A curvature radius of the object side surface of the second lens L2 is defined as R3, a curvature radius of the image side surface of the second lens L2 is defined as R4, and the camera optical lens satisfies a condition of −0.28≤(R3+R4)/(R3−R4)≤0.03, which stipulates a shape of the second lens L2 and facilitates formation of the second lens L2. Within the range according to the above condition, a degree of deflection of light passing through the lens can be alleviated, and aberrations can be reduced effectively.

An on-axis thickness of the second lens L2 is defined as d3, a total track length of each of the camera optical lenses 10 to 120 is defined as TTL, and the camera optical lens satisfies a condition of 0.056≤d3/TTL≤0.089. Within the range according to the above condition, it is conducive to reasonably controlling the total track lengths of the camera optical lenses10 to 120.

An object side surface of the third lens L3 is concave or convex in the paraxial region, and an image side surface of the third lens L3 is concave in the paraxial region. The image side surface of the third lens L3 may also be convex.

A focal length of the third lens L3 is defined as f3, and the camera optical lens satisfies a condition of −2.24≤f3/fA≤-0.46. By reasonably allocating the negative optical power of the third lens L3, it is conducive to correcting the aberration of the optical system, therefore the system can have an excellent imaging quality and a lower sensitivity.

A curvature radius of the object side surface of the third lens L3 is defined as R5, a curvature radius of an image side surface of the third lens L3 is defined as R6, and the camera optical lens satisfies a condition of −0.68≤(R5+R6)/(R5-R6)≤3.38, which stipulates a shape of the third lens L3. Within this range, a degree of deflection of light passing through the lens can be alleviated, which is conducive to correcting a problem of aberration at off-axis field angle.

An on-axis thickness of the third lens L3 is defined as d5, a total track length of each of the camera optical lenses 10 to 120 is defined as TTL, and the camera optical lens satisfies a condition of 0.011≤d5/TTL≤0.079. Within the range according to the above condition, it is conducive to reasonably controlling the total track lengths of the camera optical lenses10 to 120.

The object side surface of the fourth lens L4 is convex or concave in a paraxial region, and the image side surface of the fourth lens L4 is convex or concave in the paraxial region.

A focal length of the fourth lens L4 is defined as f4, and the camera optical lens satisfies a condition of 0.98≤f4/fA≤6.75. By defining the fourth lens L4, a light angle for each of the camera optical lenses10 to 120 can be smoothed effectively and a tolerance sensitivity can be reduced.

A curvature radius of the object side surface of the fourth lens L4 is defined as R7, a curvature radius of an image side surface of the fourth lens L4 is defined as R8, and the camera optical lens satisfies a condition of −4.00≤(R7+R8)/(R7-R8)≤18.99, which stipulates a shape of the fourth lens L4. Within this range, a development towards miniature lenses would facilitate correcting a problem of aberration at off-axis field angle.

An on-axis thickness of the fourth lens L4 is defined as d7, a total track length of each of the camera optical lenses 10 to 120 is defined as TTL, and the camera optical lens satisfies a condition of 0.037≤d7/TTL≤0.075. Within this range, it is conducive to reasonably controlling the total track lengths of the camera optical lenses 10 to 120.

An object side surface of the fifth lens L5 is convex or concave in a paraxial region, and an image side surface of the fifth lens L5 is concave or convex in the paraxial region, and the fifth lens L5 has a positive or negative refractive power.

A focal length of the fifth lens L5 is defined as f5, and the camera optical lens satisfies a condition of −4381.09≤f5/fA≤64.53. By reasonably allocating the positive refractive power of the fifth lens L5, the system can have an excellent imaging quality and a lower sensitivity.

A curvature radius of the object side surface of the fifth lens L5 is defined as R9, a curvature radius of an image side surface of the fifth lens L5 is defined as R10, and the camera optical lens satisfies a condition of −60.05< (R9+R10)/(R9−R10)≤15.60, which stipulates a shape of the fifth lens L5. Within the range according to the above condition, a development towards miniature lenses would facilitate correcting a problem of aberration at off-axis field angle.

An on-axis thickness of the fifth lens L5 is defined as d9, a total track length of each of the camera optical lenses 10 to 120 is defined as TTL, and the camera optical lens satisfies a condition of 0.018≤d9/TTL≤0.088. Within the range according to the above condition, it is conducive to reasonably controlling the total track lengths of the camera optical lenses10 to 120.

The first prism P1 is made of glass, and the first lens L1, the second lens L2, the third lens L3, the fourth lens L4, and the fifth lens L5 are all made of plastic material. In some other embodiments, the first prism P1 and the lenses may be made of other materials, respectively.

In the present disclosure, an optical element such as an optical filter GF may be arranged between the fifth lens L5 and an image surface S1. The optical filter GF may be implemented as a glass plate or an optical filter.

In the present disclosure, each of the camera optical lenses 10 to 120 may be provided with an aperture S1. The aperture S1 may be arranged between the first prism P1 and the first lens L1, or between the first lens L1 and the second lens L2. The aperture S1 may also be arranged at other positions.

In the present disclosure, a F number FNO of each of the camera optical lenses 10 to 120 is less than or equal to 2.39. In this way, the camera optical lens can have a relatively large aperture and good imaging performance. In some embodiments, the F number FNO of each of the camera optical lenses 10 to 120 is less than or equal to 2.34.

In the following, embodiments will be used to describe the camera optical lens of the present disclosure. The symbols recorded in each embodiment will be described as follows. The focal length, on-axis distance, curvature radius, and on-axis thickness are all in units of mm.

TTL: total track length (the on-axis distance from the object side surface of the first prism P1 to the image surface Si), in unit of mm.

The F number FNO refers to a ratio of an effective focal length of the camera optical lens to an entrance pupil diameter (ENPD).

In the following, the technical solutions of the present disclosure are illustrated in detail with reference to twelve embodiments.

### First Embodiment

The first prism P1 has a positive refractive power, the object side surface of the first prism is convex in the paraxial region, and the image side surface of the first prism is concave in the paraxial region.

The first lens L1 has a negative refractive power, the object side surface of the first lens is convex in the paraxial region, and the image side surface of the first lens is concave in the paraxial region.

The second lens L2 has a positive refractive power, the object side surface of the second lens is convex in the paraxial region, and the image side surface of the second lens is convex in the paraxial region.

The third lens L3 with a negative refractive power, the object side surface of the third lens is concave in the paraxial region, and the image side surface of the third lens is concave in the paraxial region.

The fourth lens L4 has a positive refractive power, the object side surface of the fourth lens is convex in the paraxial region, and the image side surface of the fourth lens is convex in the paraxial region.

The fifth lens L5 has a negative refractive power, an object side surface of the fifth lens is convex in the paraxial region, and an image side surface of the fifth lens is concave in the paraxial region.

Table 1 shows design data of the camera optical lens 10 according to the first embodiment of the present disclosure.

TABLE 1

| | R | d | | nd | | vd | |
|---|---|---|---|---|---|---|---|
| S1 | ∞ | d0= | −12.569 | | | | |
| Rp1 | 21.414 | dp1= | 9.500 | nd1 | 1.8052 | vd1 | 40.91 |
| Rp2 | 31.034 | dp2= | 2.671 | | | | |
| R1 | 5.303 | d1= | 1.559 | nd2 | 1.6400 | vd2 | 23.54 |
| R2 | 3.735 | d2= | 0.996 | | | | |
| R3 | 5.767 | d3= | 1.607 | nd3 | 1.5444 | vd3 | 55.82 |
| R4 | −5.648 | d4= | d4 | | | | |
| R5 | −5.630 | d5= | 2.000 | nd4 | 1.6153 | vd4 | 25.94 |
| R6 | 28.055 | d6= | 2.238 | | | | |
| R7 | 28.115 | d7= | 2.000 | nd5 | 1.6700 | vd5 | 19.39 |
| R8 | −31.707 | d8= | 1.460 | | | | |
| R9 | 2.158 | d9= | 0.628 | nd6 | 1.5346 | vd6 | 55.69 |
| R10 | 1.826 | d10= | d10 | | | | |
| R11 | ∞ | d11= | 0.210 | ndg | 1.5168 | vdg | 64.17 |
| R12 | ∞ | d12= | 0.643 | | | | |

Herein, dp1 is a sum of “dp1-01” and “dp1-02”, a value of “dp1-01” is 5.000, and a value of “dp1-02” is 4.500.

Table 2 shows the values of the relevant optical parameters of the camera optical lens 10, in the first state and the second state respectively, in the First Embodiment of the present disclosure.

TABLE 2

| | First state | Second state |
|---|---|---|
| fA | 15.911 | 14.862 |
| FOV | 25.00° | 24.12° |
| FNO | 2.318 | 2.621 |
| d4 | 0.254 | 0.827 |
| d10 | 2.502 | 1.929 |

Herein, meanings of various symbols will be described as follows.
S1: aperture.
R: curvature radius of an optical surface, or a central curvature radius for a lens.
Rp1: curvature radius of the object side surface of the first prism P1.
Rp2: curvature radius of the image side surface of the first prism P1.
R1: curvature radius of the object side surface of the first lens L1.
R2: curvature radius of the image side surface of the first lens L1.
R3: curvature radius of the object side surface of the second lens L2.
R4: curvature radius of the image side surface of the second lens L2.
R5: curvature radius of the object side surface of the third lens L3.
R6: curvature radius of the image side surface of the third lens L3.
R7: curvature radius of the object side surface of the fourth lens L4.
R8: curvature radius of the image side surface of the fourth lens L4.
R9: curvature radius of the object side surface of the fifth lens L5.
R10: curvature radius of the image side surface of the fifth lens L5.
R11: curvature radius of an object side surface of the optical filter (GF).
R12: curvature radius of an image side surface of the optical filter (GF).
d: on-axis thickness of a lens and an on-axis distance between lenses.
d0: on-axis distance from the aperture S1 to the object side surface of the first prism P1.
dp1: a sum of an on-axis distance between the object side surface of the first prism P1 and the reflective surface and an on-axis distance between the reflective surface and the image side surface of the first prism P1.
dp1-01: on-axis distance between the object side surface of the first prism P1 and the reflective surface.
dp1-02: on-axis distance between the reflective surface and the image side surface of the first prism P1.
dp2: on-axis distance between the image side surface of the first prism P1 and the object side surface of the first lens L1.
d1: on-axis thickness of the first lens L1.
d2: on-axis distance from the image side surface of the first lens L1 to the object side surface of the second lens L2.
d3: on-axis thickness of the second lens L2.
d4: on-axis distance from the image side surface of the second lens L2 to the object side surface of the third lens L3.
d5: on-axis thickness of the third lens L3.
d6: on-axis distance from the image side surface of the third lens L3 to the object side surface of the fourth lens L4.
d7: on-axis thickness of the fourth lens L4.
d8: on-axis distance from the image side surface of the fourth lens L4 to the object side surface of the fifth lens L5.
d9: on-axis thickness of the fifth lens L5.
d10: on-axis distance from the image side surface of the fifth lens L5 to the object side surface of the optical filter (GF).
d11: on-axis thickness of the optical filter (GF).
d12: on-axis distance from the image side surface of the optical filter (GF) to the image surface Si.
nd: refractive index of a d line.
nd1: refractive index of the d line of the first prism P1.
nd2: refractive index of the d line of the first lens L1.
nd3: refractive index of the d line of the second lens L2.
nd4: refractive index of the d line of the third lens L3.
nd5: refractive index of the d line of the fourth lens L4.
nd6: refractive index of the d line of the fifth lens L5.
ndg: refractive index of the d line of the optical filter (GF).
vd: abbe number.
vd1: abbe number of the first prism P1.
vd2: abbe number of the first lens L1.
vd3: abbe number of the second lens L2.
vd4: abbe number of the third lens L3.
vd5: abbe number of the fourth lens L4.
vd6: abbe number of the fifth lens L5.
vdg: abbe number of the optical filter (GF).

Table 3 shows aspherical surface data of each lens of the camera optical lens 10 in the First Embodiment of the present disclosure.

TABLE 3

| | Conic | | | | | |
|---|---|---|---|---|---|---|
| | coefficient | Aspheric surface coefficients | | | | |
| | k | A4 | A6 | A8 | A10 | A12 |
| Rp1 | — | 9.89500E−05 | 1.09950E−06 | −1.75520E− | 1.47620E−08 | −7.42350E− |
| Rp2 | 0.00000E+00 | 0.00000E+00 | 0.00000E+00 | 0.00000E+00 | 0.00000E+00 | 0.00000E+00 |
| R1 | — | −1.72440E− | −2.74300E− | −2.11270E− | 1.85340E−05 | −1.25710E− |
| R2 | −7.67014E− | −6.76730E− | −7.28730E− | 4.87880E−04 | −2.98870E− | 1.22740E−04 |
| R3 | — | 6.90590E−03 | −2.49820E− | 6.88540E−04 | −2.10220E− | 5.38060E−05 |
| R4 | 4.12313E−01 | 5.71320E−04 | −1.75040E− | 1.19900E−04 | −8.19190E− | 3.19720E−05 |
| R5 | — | −1.07200E− | 5.46850E−03 | −2.17030E− | 6.62910E−04 | −1.46850E− |
| R6 | 9.42229E+01 | 3.69630E−03 | −6.79720E− | 1.04930E−03 | −1.54770E− | 1.33780E−03 |
| R7 | 9.27344E+01 | −6.32470E− | 1.77490E−03 | −8.99920E− | 2.44490E−04 | −2.15370E− |
| R8 | 4.86465E+01 | −1.49190E− | 6.22510E−03 | −2.65400E− | 8.83150E−04 | −2.16900E− |
| R9 | — | 3.28900E−03 | −1.40030E− | 6.47880E−03 | −1.82720E− | 3.55590E−04 |
| R10 | — | −5.58700E− | −6.39430E− | 2.55150E−03 | −1.30630E− | −2.38130E− |
| | Conic | | | | | |
| | coefficient | Aspheric surface coefficients | | | | |
| | k | A14 | A16 | A18 | A20 | A22 |
| Rp1 | — | 2.32320E−11 | −4.42110E− | 4.68910E−15 | −2.12820E− | 0.00E+00 |
| Rp2 | 0.00000E+00 | 0.00000E+00 | 0.00000E+00 | 0.00000E+00 | 0.00000E+00 | 0.00E+00 |
| R1 | — | 4.41800E−06 | −9.07920E− | 1.09430E−07 | −7.13700E− | 1.93E−10 |
| R2 | −7.67014E− | −3.25480E− | 5.56720E−06 | −5.92800E− | 3.58730E−08 | −9.49E−10 |
| R3 | — | −9.69580E− | 1.11700E−06 | −7.17800E− | 1.95850E−09 | 0.00E+00 |
| R4 | 4.12313E−01 | −7.27420E− | 9.67750E−07 | −6.96280E− | 2.13410E−09 | 0.00E+00 |
| R5 | — | 2.23220E−05 | −2.18680E− | 1.23860E−07 | −3.07210E− | 0.00E+00 |
| R6 | 9.42229E+01 | −7.68820E− | 3.08230E−04 | −8.81010E− | 1.80660E−05 | −2.64E−06 |
| R7 | 9.27344E+01 | −1.12380E− | 5.41420E−06 | −1.51370E− | 3.88870E−07 | −8.73E−08 |
| R8 | 4.86465E+01 | 3.79800E−05 | −4.64590E− | 3.86480E−07 | −2.07980E− | 6.52E−10 |
| R9 | — | −4.88640E− | 4.71760E−06 | −3.12160E− | 1.34440E−08 | −3.39E−10 |
| R10 | — | 1.08950E−04 | −2.63020E− | 4.15840E−06 | −4.55760E− | 3.50E−08 |

| | Conic | | | | |
|---|---|---|---|---|---|
| | coefficient | Aspheric surface coefficients | | | |
| | k | A24 | A26 | A28 | A30 |
| Rp1 | — | 0.00E+00 | 0.00E+00 | 0.00E+00 | 0.00E+00 |
| Rp2 | 0.00000E+00 | 0.00E+00 | 0.00E+00 | 0.00E+00 | 0.00E+00 |
| R1 | — | 0.00E+00 | 0.00E+00 | 0.00E+00 | 0.00E+00 |
| R2 | −7.67014E− | 0.00E+00 | 0.00E+00 | 0.00E+00 | 0.00E+00 |
| R3 | — | 0.00E+00 | 0.00E+00 | 0.00E+00 | 0.00E+00 |
| R4 | 4.12313E−01 | 0.00E+00 | 0.00E+00 | 0.00E+00 | 0.00E+00 |
| R5 | — | 0.00E+00 | 0.00E+00 | 0.00E+00 | 0.00E+00 |
| R6 | 9.42229E+01 | 2.68E−07 | −1.79E−08 | 7.13E−10 | −1.28E−11 |
| R7 | 9.27344E+01 | 1.40E−08 | −1.41E−09 | 7.91E−11 | −1.90E−12 |
| R8 | 4.86465E+01 | −9.05E−12 | 0.00E+00 | 0.00E+00 | 0.00E+00 |
| R9 | — | 3.78E−12 | 0.00E+00 | 0.00E+00 | 0.00E+00 |
| R10 | — | −1.86E−09 | 6.48E−11 | −1.34E−12 | 1.25E−14 |

For convenience, an aspheric surface of each lens surface uses the aspheric surfaces as expressed in the following condition (1). However, the present disclosure is not limited to the aspherical polynomials form as expressed in the condition (1).

$$z = ( {cr}^{2} ) / \{ 1 + {[ 1 - ( k + 1 ) ( {c}^{2} {r}^{2} ) ]}^{1 / 2} \} + {A 4 r}^{4} + {A 6 r}^{6} + {A 8 r}^{8} + {A 10 r}^{10} + {A 12 r}^{12} + {A 14 r}^{14} + {A 16 r}^{16} + {A 18 r}^{18} + {A 20 r}^{20} + {A 22 r}^{22} + {A 24 r}^{24} + {A 26 r}^{26} + {A 28 r}^{28} + {A 30 r}^{30} \qquad ( 1 )$$

Herein, K is a conic coefficient, A4, A6, A8, A10, A12, A14, A16, A18, A20, A22, A24, A26, A28, and A30 are aspheric surface coefficients, c is a central curvature of an optical surface, r is a vertical distance between a point on an aspheric curve and the optical axis, and z is a depth of the aspheric surface (the vertical distance between a point on the aspheric surface from which a vertical distance to the optical axis is r and a tangent plane tangent to a vertex on the optical axis of the aspheric surface).

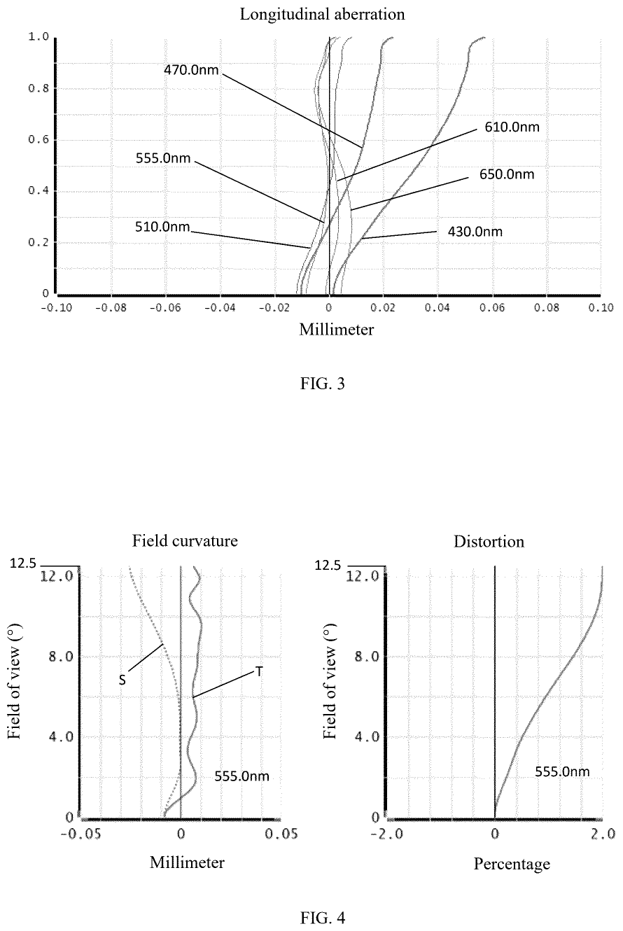

FIG. 2 and FIG. 3 schematically illustrate a lateral color and a longitudinal aberration of the camera optical lens 10 in the first state according to the First Embodiment after light with wavelengths of 650 nm, 610 nm, 555 nm, 510 nm, 470 nm, and 430 nm passing through the camera optical lens 10, respectively. FIG. 4 schematically illustrates a field curvature and a distortion of the camera optical lens 10 in the first state after light with a wavelength of 555 nm passing through the camera optical lens 10 according to the First Embodiment. A field curvature S in FIG. 4 is a field curvature in a sagittal direction, and T is a field curvature in a tangential direction.

Table 37 in the following lists various values in the First Embodiment, Second Embodiment, Third Embodiment, Fourth Embodiment, Fifth Embodiment, Sixth Embodiment, Seventh Embodiment, Eighth Embodiment, Ninth Embodiment, Tenth Embodiment, Eleventh Embodiment, and Twelfth Embodiment corresponding to parameters in the above conditions.

It can be derived, according to Table 37, that the First Embodiment satisfies the conditions.

In the embodiment, an entrance pupil diameter (ENPD) of the camera optical lens 10 in the first state is 6.863 mm, an image height IH of 1.0H is 3.600 mm, and a diagonal field of view FOV is 25.00°. Thus, the camera optical lens 10 can meet the design requirements of large aperture, long focal length, and miniaturization, and on-axis and off-axis chromatic aberrations of the camera optical lens 10 can be completely corrected, thereby having excellent optical characteristics.

### Second Embodiment

The symbols in the Second Embodiment have the same meanings as those in the First Embodiment. In the following, only the differences are illustrated.

The Second Embodiment differs from the First Embodiment in that in the Second Embodiment, the image side surface of the first prism P1 is planar in the paraxial region.

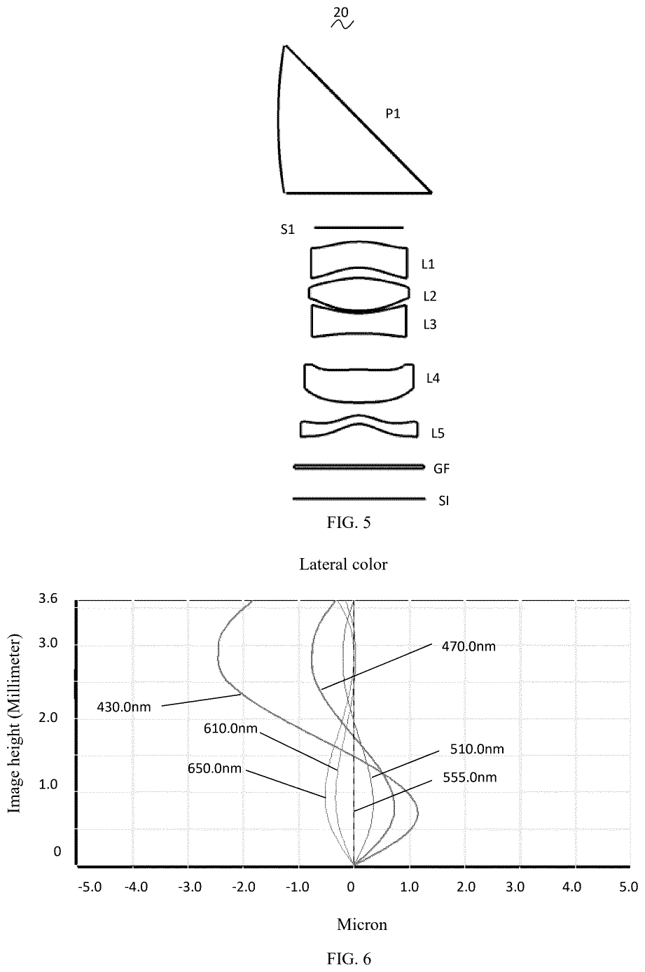

The camera optical lens 20 according to the Second Embodiment is shown in FIG. 5.

Table 4 shows design data of the camera optical lens 20 according to the Second Embodiment of the present disclosure.

TABLE 4

| | R | d | | nd | | vd | |
|---|---|---|---|---|---|---|---|
| S1 | ∞ | d0= | −11.607 | | | | |
| Rp1 | 29.143 | dp1= | 9.500 | nd1 | 1.8052 | vd1 | 40.91 |
| Rp2 | ∞ | dp2= | 2.954 | | | | |
| R1 | 6.005 | d1= | 1.580 | nd2 | 1.6400 | vd2 | 23.54 |
| R2 | 3.785 | d2= | 0.628 | | | | |
| R3 | 5.919 | d3= | 2.000 | nd3 | 1.5444 | vd3 | 55.82 |
| R4 | −5.637 | d4= | d4 | | | | |
| R5 | −5.665 | d5= | 1.248 | nd4 | 1.6153 | vd4 | 25.94 |
| R6 | 28.546 | d6= | 2.202 | | | | |
| R7 | 28.181 | d7= | 2.000 | nd5 | 1.6700 | vd5 | 19.39 |
| R8 | −38.472 | d8= | 0.791 | | | | |
| R9 | 1.867 | d9= | 0.519 | nd6 | 1.5346 | vd6 | 55.69 |
| R10 | 1.642 | d10= | d10 | | | | |
| R11 | ∞ | d11= | 0.210 | ndg | 1.5168 | vdg | 64.17 |
| R12 | ∞ | d12= | 1.854 | | | | |

Herein, dp1 is a sum of “dp1-01” and “dp1-02”, a value of “dp1-01” is 5.000, and a value of “dp1-02” is 4.500.

Table 5 shows the values of the relevant optical parameters of the camera optical lens 20, in the first state and the second state respectively, in the Second Embodiment of the present disclosure.

TABLE 5

| | First state | Second state |
|---|---|---|
| fA | 15.912 | 14.841 |
| FOV | 25.00° | 24.30° |
| FNO | 2.318 | 2.630 |
| d4 | 0.136 | 0.736 |
| d10 | 2.502 | 1.902 |

Table 6 shows aspherical surface data of each lens of the camera optical lens 20 in the Second Embodiment of the present disclosure.

TABLE 6

| | Conic | | | | | |
|---|---|---|---|---|---|---|
| | coefficient | Aspheric surface coefficients | | | | |
| | k | A4 | A6 | A8 | A10 | A12 |
| Rp1 | — | 6.64980E−05 | 1.34780E−06 | −2.45650E− | 2.49670E−08 | −1.55490E− |
| Rp2 | 0.00000E+00 | 0.00000E+00 | 0.00000E+00 | 0.00000E+00 | 0.00000E+00 | 0.00000E+0 |
| R1 | — | −2.03210E− | −9.29910E− | −9.84400E− | 5.70690E−05 | −1.80880E− |
| R2 | −7.36802E− | −6.60990E− | −4.43530E− | 8.03610E−06 | 5.47680E−05 | −2.61680E− |
| R3 | — | 6.46460E−03 | −2.34120E− | 4.58400E−04 | −6.07230E− | 2.64070E−06 |
| R4 | 1.64382E−01 | 3.08740E−04 | 1.60970E−04 | −1.80840E− | 8.29180E−05 | −2.01220E− |
| R5 | — | −1.04000E− | 5.66050E−03 | −2.29570E− | 6.93200E−04 | −1.48130E− |
| R6 | 9.55233E+01 | 4.89120E−03 | −2.59550E− | 3.13950E−03 | −3.36540E− | 2.51470E−03 |
| R7 | 9.24888E+01 | −3.22170E− | −2.24630E− | 3.83890E−03 | −4.22880E− | 3.04030E−03 |
| R8 | 4.96670E+01 | −1.92040E− | 9.20240E−03 | −4.11930E− | 1.40520E−03 | −3.54410E− |
| R9 | — | 4.31230E−03 | −1.91550E− | 9.82250E−03 | −3.08860E− | 6.70770E−04 |
| R10 | — | −5.82340E− | −9.52730E− | 3.83580E−03 | 7.47590E−05 | −6.39990E− |
| | Conic | | | | | |
| | coefficient | Aspheric surface coefficients | | | | |
| | k | A14 | A16 | A18 | A20 | A22 |
| Rp1 | — | 6.11610E−11 | −1.48560E− | 2.03970E−14 | −1.21360E− | 0.00E+00 |
| Rp2 | 0.00000E+00 | 0.00000E+00 | 0.00000E+00 | 0.00000E+00 | 0.00000E+00 | 0.00E+00 |
| R1 | — | 3.41290E−06 | −3.80090E− | 2.28740E−08 | −5.63130E− | −9.50E−13 |
| R2 | −7.36802E− | 6.62810E−06 | −9.77070E− | 8.28470E−08 | −3.72770E− | 6.84E−11 |
| R3 | — | 9.00980E−07 | −1.77540E− | 1.28290E−08 | −3.36850E− | 0.00E+00 |
| R4 | 1.64382E−01 | 2.86500E−06 | −2.27760E− | 8.86220E−09 | −1.04350E− | 0.00E+00 |
| R5 | — | 2.13200E−05 | −1.94580E− | 1.01060E−07 | −2.26640E− | 0.00E+00 |
| R6 | 9.55233E+01 | −1.33460E− | 5.11210E−04 | −1.42360E− | 2.87780E−05 | −4.17E−06 |
| R7 | 9.24888E+01 | −1.52020E− | 5.44430E−04 | −1.41700E− | 2.68720E−05 | −3.68E−06 |
| R8 | 4.96670E+01 | 6.42340E−05 | −8.17940E− | 7.10370E−07 | −3.99310E− | 1.31E−09 |
| R9 | — | −1.02950E− | 1.11190E−05 | −8.24420E− | 3.98180E−08 | −1.12E−09 |
| R10 | — | 2.98860E−04 | −7.86340E− | 1.37600E−05 | −1.67830E− | 1.44E−07 |

| | Conic | | | | |
|---|---|---|---|---|---|
| | coefficient | Aspheric surface coefficients | | | |
| | k | A24 | A26 | A28 | A30 |
| Rp1 | — | 0.00E+00 | 0.00E+00 | 0.00E+00 | 0.00E+00 |
| Rp2 | 0.00000E+00 | 0.00E+00 | 0.00E+00 | 0.00E+00 | 0.00E+00 |
| R1 | — | 0.00E+00 | 0.00E+00 | 0.00E+00 | 0.00E+00 |
| R2 | −7.36802E− | 0.00E+00 | 0.00E+00 | 0.00E+00 | 0.00E+00 |
| R3 | — | 0.00E+00 | 0.00E+00 | 0.00E+00 | 0.00E+00 |
| R4 | 1.64382E−01 | 0.00E+00 | 0.00E+00 | 0.00E+00 | 0.00E+00 |
| R5 | — | 0.00E+00 | 0.00E+00 | 0.00E+00 | 0.00E+00 |
| R6 | 9.55233E+01 | 4.22E−07 | −2.83E−08 | 1.13E−09 | −2.02E−11 |
| R7 | 9.24888E+01 | 3.54E−07 | −2.27E−08 | 8.74E−10 | −1.52E−11 |
| R8 | 4.96670E+01 | −1.88E−11 | 0.00E+00 | 0.00E+00 | 0.00E+00 |
| R9 | — | 1.41E−11 | 0.00E+00 | 0.00E+00 | 0.00E+00 |
| R10 | — | −8.52E−09 | 3.32E−10 | −7.69E−12 | 8.00E−14 |

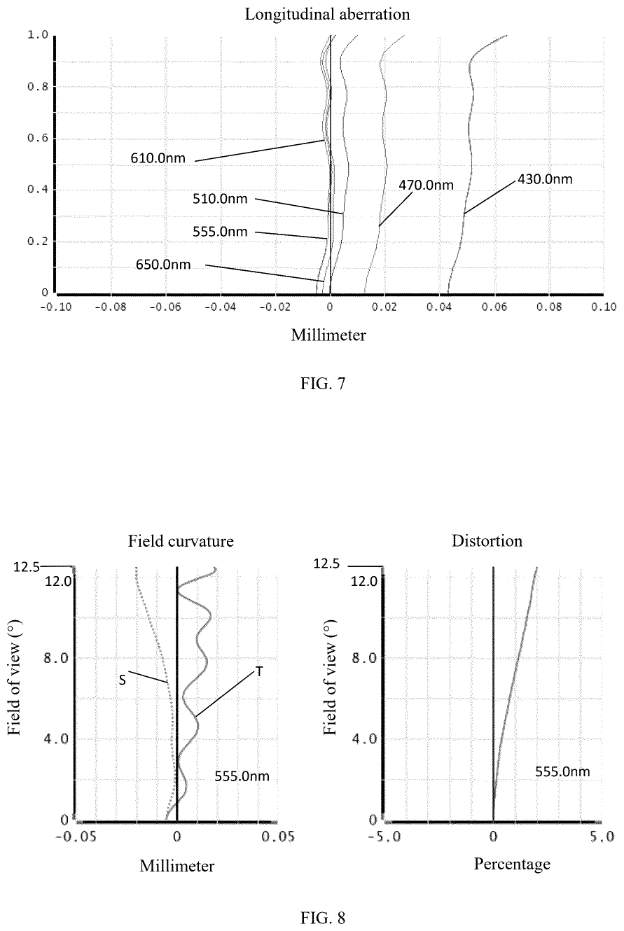

FIG. 6 and FIG. 7 schematically illustrate a lateral color and a longitudinal aberration of the camera optical lens 20 in the first state according to the Second Embodiment after light with wavelengths of 650 nm, 610 nm, 555 nm, 510 nm, 470 nm, and 430 nm passing through the camera optical lens 20, respectively. FIG. 8 schematically illustrates a field curvature and a distortion of the camera optical lens 20 in the first state after light with a wavelength of 555 nm passing through the camera optical lens 20 according to the Second Embodiment. A field curvature S in FIG. 8 is a field curvature in a sagittal direction, and T is a field curvature in a tangential direction.

It can be derived, according to Table 37, that the Second Embodiment satisfies the conditions.

In the embodiment, an entrance pupil diameter (ENPD) of the camera optical lens 20 in the first state is 6.863 mm, an image height IH of 1.0H is 3.600 mm, and a diagonal field of view FOV is 25.00°. Thus, the camera optical lens 20 can meet the design requirements of long focal length, large aperture, and miniaturization, and on-axis and off-axis chromatic aberrations of the camera optical lens 20 can be completely corrected, thereby having excellent optical characteristics.

### Third Embodiment

The symbols in the Third Embodiment have the same meanings as those in the First Embodiment. In the following, only the differences are illustrated.

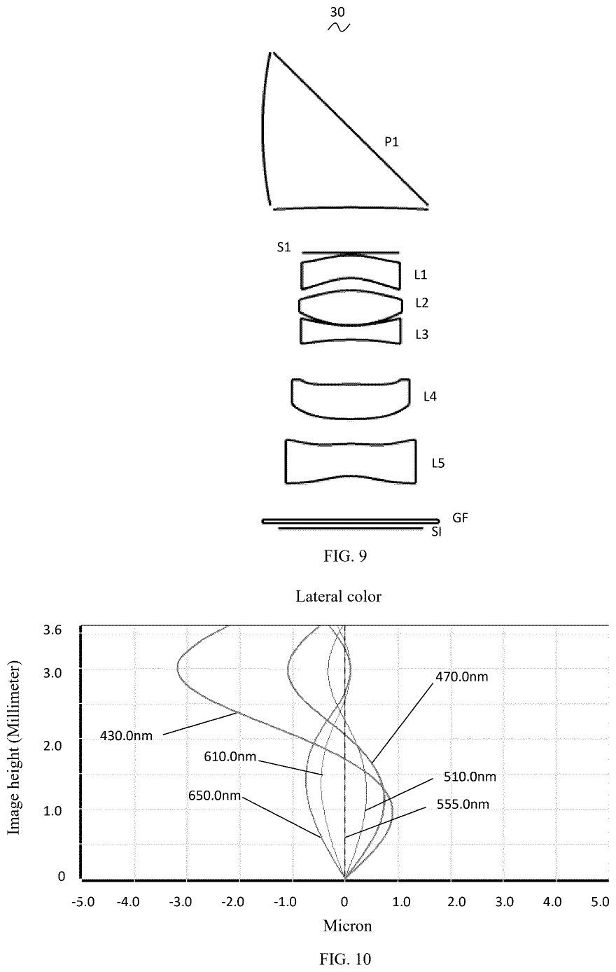

The camera optical lens 30 according to the Third Embodiment is shown in FIG. 9.

Table 7 shows design data of the camera optical lens 30 according to the Third Embodiment of the present disclosure.

TABLE 7

| | R | d | | nd | | vd | |
|---|---|---|---|---|---|---|---|
| S1 | ∞ | d0= | −12.124 | | | | |
| Rp1 | 23.442 | dp1= | 9.500 | nd1 | 1.8052 | vd1 | 40.91 |
| Rp2 | 78.140 | dp2= | 2.752 | | | | |
| R1 | 5.536 | d1= | 1.316 | nd2 | 1.6400 | vd2 | 23.54 |
| R2 | 3.673 | d2= | 0.701 | | | | |
| R3 | 5.600 | d3= | 2.000 | nd3 | 1.5444 | vd3 | 55.82 |
| R4 | −5.885 | d4= | d4 | | | | |
| R5 | −5.970 | d5= | 0.803 | nd4 | 1.6153 | vd4 | 25.94 |
| R6 | 27.544 | d6= | 2.561 | | | | |
| R7 | 27.184 | d7= | 2.000 | nd5 | 1.6700 | vd5 | 19.39 |
| R8 | −23.048 | d8= | 1.420 | | | | |
| R9 | 8.536 | d9= | 1.843 | nd6 | 1.5346 | vd6 | 55.69 |
| R10 | 4.271 | d10= | d10 | | | | |
| R11 | ∞ | d11= | 0.210 | ndg | 1.5168 | vdg | 64.17 |
| R12 | ∞ | d12= | 0.295 | | | | |

Herein, dp1 is a sum of “dp1-01” and “dp1-02”, a value of “dp1-01” is 5.000, and a value of “dp1-02” is 4.500.

Table 8 shows the values of the relevant optical parameters of the camera optical lens 30, in the first state and the second state respectively, in the Third Embodiment of the present disclosure.

TABLE 8

| | First state | Second state |
|---|---|---|
| fA | 16.540 | 15.420 |
| FOV | 24.56° | 23.89° |
| FNO | 2.318 | 2.618 |
| d4 | 0.030 | 0.612 |
| d10 | 2.502 | 1.920 |

Table 9 shows aspherical surface data of each lens of the camera optical lens 30 in the Third Embodiment of the present disclosure.

TABLE 9

| | Conic | | | | | |
|---|---|---|---|---|---|---|
| | coefficient | Aspheric surface coefficients | | | | |
| | k | A4 | A6 | A8 | A10 | A12 |
| Rp1 | — | 7.75020E−05 | 2.24890E−07 | −4.70860E− | 4.13770E−09 | −2.07020E− |
| Rp2 | 0.00000E+00 | 0.00000E+00 | 0.00000E+00 | 0.00000E+00 | 0.00000E+00 | 0.00000E+0 |
| R1 | — | −2.14970E− | −2.12530E− | 4.38710E−05 | −2.71640E− | 1.26150E−05 |
| R2 | −7.58454E− | −7.43320E− | −3.31030E− | 1.53670E−04 | −5.94670E− | 1.80190E−05 |
| R3 | — | 6.98250E−03 | −2.55530E− | 6.63690E−04 | −1.70330E− | 3.68970E−05 |
| R4 | 4.37705E−01 | 1.43100E−03 | −1.10400E− | 6.22330E−04 | −2.37550E− | 6.00660E−05 |
| R5 | — | −6.89010E− | 3.64280E−03 | −1.26930E− | 3.13430E−04 | −5.55240E− |
| R6 | 8.90104E+01 | 5.97290E−03 | −2.14240E− | 2.18910E−03 | −2.44920E− | 1.93780E−03 |
| R7 | 8.81362E+01 | −5.20370E− | −8.65770E− | 1.87290E−03 | −2.27530E− | 1.82820E−03 |
| R8 | 4.38192E+01 | −8.27800E− | 1.05660E−03 | −7.24360E− | −3.43210E− | 1.85910E−05 |
| R9 | — | −1.26410E− | 5.34650E−04 | 1.59060E−04 | −3.06090E− | 1.38330E−06 |
| R10 | — | −8.72580E− | −2.14400E− | 8.86820E−04 | −5.18060E− | 2.00980E−04 |
| | Conic | | | | | |
| | coefficient | Aspheric surface coefficients | | | | |
| | k | A14 | A16 | A18 | A20 | A22 |
| Rp1 | — | 6.48410E−12 | −1.24880E− | 1.35320E−15 | −6.32120E− | 0.00E+00 |
| Rp2 | 0.00000E+00 | 0.00000E+00 | 0.00000E+00 | 0.00000E+00 | 0.00000E+00 | 0.00E+00 |
| R1 | — | −3.82050E− | 7.35880E−07 | −8.71150E− | 5.78120E−09 | −1.65E−10 |
| R2 | −7.58454E− | −3.56090E− | 4.39470E−07 | −3.15080E− | 1.17100E−09 | −1.74E−11 |
| R3 | — | −5.75890E− | 5.84990E−07 | −3.35330E− | 8.18030E−10 | 0.00E+00 |
| R4 | 4.37705E−01 | −9.87820E− | 1.01680E−06 | −5.93590E− | 1.50960E−09 | 0.00E+00 |
| R5 | — | 6.82900E−06 | −5.49480E− | 2.57370E−08 | −5.25270E− | 0.00E+00 |
| R6 | 8.90104E+01 | −1.08330E− | 4.33430E−04 | −1.25140E− | 2.60760E−05 | −3.88E−06 |
| R7 | 8.81362E+01 | −1.02910E− | 4.14300E−04 | −1.20480E− | 2.53200E−05 | −3.80E−06 |
| R8 | 4.38192E+01 | −5.01920E− | 8.59530E−07 | −9.61690E− | 6.80980E−09 | −2.77E−10 |
| R9 | — | 4.39290E−07 | −1.12630E− | 1.35740E−08 | −9.60620E− | 3.84E−11 |
| R10 | — | −5.57830E− | 1.12600E−05 | −1.66230E− | 1.79100E−07 | −1.39E−08 |

| | Conic | | | | |
|---|---|---|---|---|---|
| | coefficient | Aspheric surface coefficients | | | |
| | k | A24 | A26 | A28 | A30 |
| Rp1 | — | 0.00E+00 | 0.00E+00 | 0.00E+00 | 0.00E+00 |
| Rp2 | 0.00000E+00 | 0.00E+00 | 0.00E+00 | 0.00E+00 | 0.00E+00 |
| R1 | — | 0.00E+00 | 0.00E+00 | 0.00E+00 | 0.00E+00 |
| R2 | −7.58454E− | 0.00E+00 | 0.00E+00 | 0.00E+00 | 0.00E+00 |
| R3 | — | 0.00E+00 | 0.00E+00 | 0.00E+00 | 0.00E+00 |
| R4 | 4.37705E−01 | 0.00E+00 | 0.00E+00 | 0.00E+00 | 0.00E+00 |
| R5 | — | 0.00E+00 | 0.00E+00 | 0.00E+00 | 0.00E+00 |
| R6 | 8.90104E+01 | 4.02E−07 | −2.75E−08 | 1.12E−09 | −2.04E−11 |
| R7 | 8.81362E+01 | 3.98E−07 | −2.75E−08 | 1.13E−09 | −2.09E−11 |
| R8 | 4.38192E+01 | 4.95E−12 | 0.00E+00 | 0.00E+00 | 0.00E+00 |
| R9 | — | −6.68E−13 | 0.00E+00 | 0.00E+00 | 0.00E+00 |
| R10 | — | 7.57E−10 | −2.74E−11 | 5.93E−13 | −5.79E−15 |

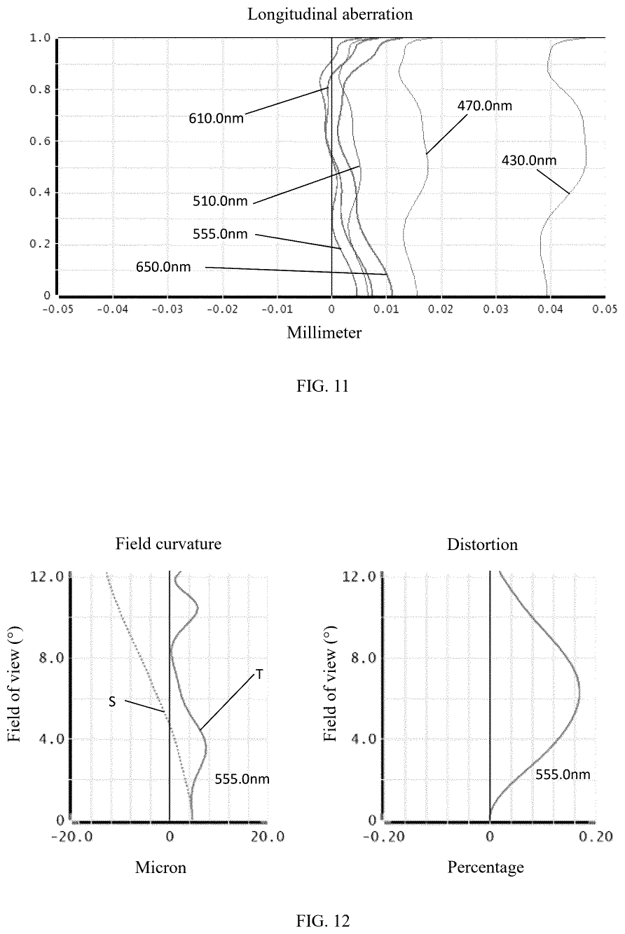

FIG. 10 and FIG. 11 schematically illustrate a lateral color and a longitudinal aberration of the camera optical lens 30 in the first state according to the Third Embodiment after light with wavelengths of 650 nm, 610 nm, 555 nm, 510 nm, 470 nm, and 430 nm passing through the camera optical lens 30, respectively. FIG. 12 schematically illustrates a field curvature and a distortion of the camera optical lens 30 in the first state after light with a wavelength of 555 nm passing through the camera optical lens 30 according to the Third Embodiment. A field curvature S in FIG. 12 is a field curvature in a sagittal direction, and T is a field curvature in a tangential direction.

It can be derived, according to Table 37, that the Third Embodiment satisfies the conditions.

In the embodiment, an entrance pupil diameter (ENPD) of the camera optical lens 30 in the first state is 7.134 mm, an image height IH of 1.0H is 3.600 mm, and a diagonal field of view FOV is 24.56°. Thus, the camera optical lens 30 can meet the design requirements of long focal length, large aperture, and miniaturization, and on-axis and off-axis chromatic aberrations of the camera optical lens 30 can be completely corrected, thereby having excellent optical characteristics.

### Fourth Embodiment

The symbols in the Fourth Embodiment have the same meanings as those in the First Embodiment. In the following, only the differences are illustrated.

The Fourth Embodiment differs from the First Embodiment in that in the Fourth Embodiment, the object side surface of the first prism P1 is planar in the paraxial region, the image side surface of the first prism P1 is convex in the paraxial region, the object side surface of the third lens L3 is convex in the paraxial region, the object side surface of the fourth lens L4 is concave in the paraxial region, the object side surface of the fifth lens L5 is concave in the paraxial region, and the image side surface of the fifth lens L5 is convex in the paraxial region.

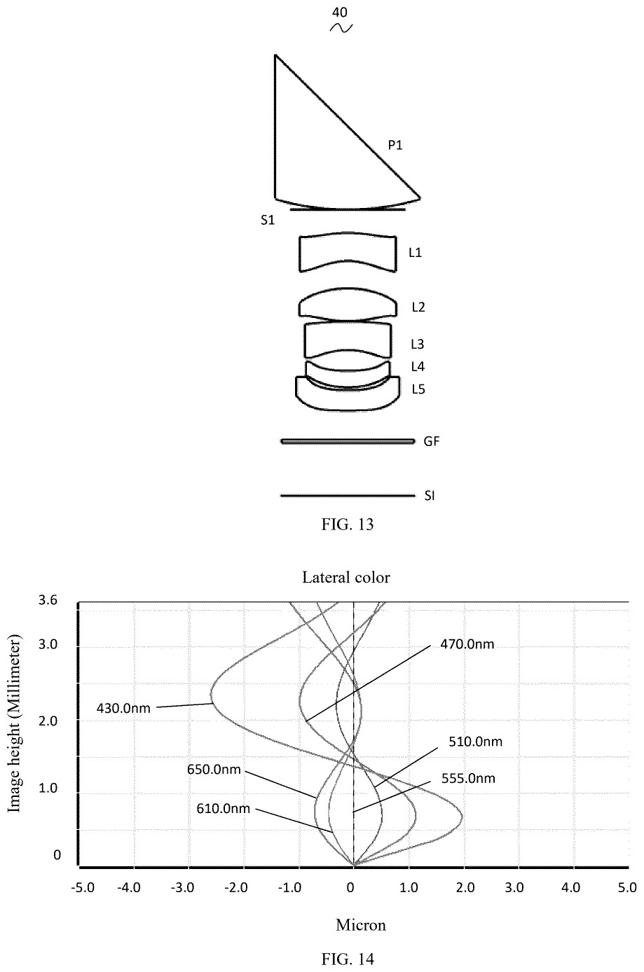

The camera optical lens 40 according to the Fourth Embodiment is shown in FIG. 13.

Table 10 shows design data of the camera optical lens 40 according to the Fourth Embodiment of the present disclosure.

TABLE 10

| | R | d | | nd | | vd | |
|---|---|---|---|---|---|---|---|
| S1 | ∞ | d0= | −9.500 | | | | |
| Rp1 | ∞ | dp1= | 9.500 | nd1 | 40.9100 | vd1 | 0.00 |
| Rp2 | −15.466 | dp2= | 1.425 | | | | |
| R1 | 7.129 | d1= | 1.716 | nd2 | 1.6400 | vd2 | 23.54 |
| R2 | 3.667 | d2= | 1.683 | | | | |
| R3 | 6.021 | d3= | 2.000 | nd3 | 1.5444 | vd3 | 55.82 |
| R4 | −6.898 | d4= | d4 | | | | |
| R5 | 18.689 | d5= | 1.736 | nd4 | 1.6153 | vd4 | 25.94 |
| R6 | 4.148 | d6= | 1.278 | | | | |
| R7 | −10.191 | d7= | 1.000 | nd5 | 1.6700 | vd5 | 19.39 |
| R8 | −9.171 | d8= | 0.177 | | | | |
| R9 | −3227.071 | d9= | 1.250 | nd6 | 1.5346 | vd6 | 55.69 |
| R10 | −3567.876 | d10= | d10 | | | | |
| R11 | ∞ | d11= | 0.210 | ndg | 1.5168 | vdg | 64.17 |
| R12 | ∞ | d12= | 3.236 | | | | |

Herein, dp1 is a sum of “dp1-01” and “dp1-02”, a value of “dp1-01” is 5.000, and a value of “dp1-02” is 4.500.

Table 11 shows the values of the relevant optical parameters of the camera optical lens 40, in the first state and the second state respectively, in the Fourth Embodiment of the present disclosure.

TABLE 11

| | First state | Second state |
|---|---|---|
| fA | 14.396 | 13.681 |
| FOV | 27.99° | 25.85° |
| FNO | 1.983 | 2.354 |
| d4 | 0.030 | 0.640 |
| d10 | 1.768 | 1.158 |

Table 12 shows aspherical surface data of each lens of the camera optical lens 40 in the Fourth Embodiment of the present disclosure.

TABLE 12

| | Conic | | | | | |
|---|---|---|---|---|---|---|
| | coefficient | Aspheric surface coefficients | | | | |
| | k | A4 | A6 | A8 | A10 | A12 |
| Rp1 | 0.00000E+00 | 0.00000E+00 | 0.00000E+00 | 0.00000E+00 | 0.00000E+00 | 0.00000E+0 |
| Rp2 | 0.00000E+00 | 0.00000E+00 | 0.00000E+00 | 0.00000E+00 | 0.00000E+00 | 0.00000E+0 |
| R1 | — | −3.63350E− | −1.49240E− | −7.13490E− | 3.16760E−06 | −3.70690E− |
| R2 | −7.57711E− | −6.03130E− | −4.32350E− | 6.21780E−05 | −1.66050E− | 5.70440E−06 |
| R3 | — | 6.66240E−03 | −6.28820E− | 4.54470E−05 | 1.19990E−05 | −4.34010E− |
| R4 | — | 1.97000E−06 | 1.32370E−03 | −8.58340E− | 3.84440E−04 | −1.08450E− |
| R5 | 2.25578E+01 | −2.63050E− | 1.77590E−03 | −1.15990E− | 5.21670E−04 | −1.55730E− |
| R6 | — | 2.34620E−02 | −1.00900E− | 3.80860E−03 | −1.08650E− | 1.61280E−04 |
| R7 | 1.27581E+00 | −1.78700E− | 9.69980E−03 | −5.93950E− | 2.92340E−03 | −1.14180E− |
| R8 | — | −6.26290E− | 4.89460E−02 | −2.70870E− | 1.09090E−02 | −3.17850E− |
| R9 | — | −7.88320E− | 5.63860E−02 | −2.96800E− | 1.10380E−02 | −2.92360E− |
| R10 | — | −1.44830E− | 3.65820E−03 | −1.42590E− | 4.10570E−04 | −8.74180E− |
| | Conic | | | | | |
| | coefficient | Aspheric surface coefficients | | | | |
| | k | A14 | A16 | A18 | A20 | A22 |
| Rp1 | 0.00000E+00 | 0.00000E+00 | 0.00000E+00 | 0.00000E+00 | 0.00000E+00 | |
| Rp2 | 0.00000E+00 | 0.00000E+00 | 0.00000E+00 | 0.00000E+00 | 0.00000E+00 | |
| R1 | — | 1.35420E−08 | 1.22190E−09 | −1.09220E− | 6.93850E−13 | |
| R2 | −7.57711E− | −1.19100E− | 1.41820E−07 | −9.05340E− | 2.39560E−10 | |
| R3 | — | 7.75760E−07 | −8.00910E− | 4.62190E−09 | −1.10920E− | |
| R4 | — | 1.97610E−05 | −2.23900E− | 1.43410E−07 | −3.94020E− | |
| R5 | 2.25578E+01 | 3.03850E−05 | −3.72550E− | 2.60290E−07 | −7.88380E− | |
| R6 | — | 3.97620E−06 | −6.21380E− | 9.83940E−07 | −5.25520E− | |
| R7 | 1.27581E+00 | 3.06600E−04 | −5.26120E− | 5.23840E−06 | −2.29080E− | |
| R8 | — | 6.31230E−04 | −7.95220E− | 5.69730E−06 | −1.76070E− | |
| R9 | — | 5.20470E−04 | −5.74600E− | 3.46300E−06 | −8.42500E− | |
| R10 | — | 1.28710E−05 | −1.20670E− | 6.37610E−08 | −1.43740E− | |

In the Fourth Embodiment, an aspheric surface of each lens surface of the camera optical lens 40 uses a respective aspheric surface as expressed in the following condition (2).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 2 )$$

Herein, k is a conic coefficient, A4, A6, A8, A10, A12, A14, A16, A18, and A20 are aspheric surface coefficients, c is a central curvature of an optical surface, r is a vertical distance between a point on an aspheric curve and the optical axis, and z is a depth of the aspheric surface (the vertical distance between a point on the aspheric surface from which a vertical distance to the optical axis is r and a tangent plane tangent to a vertex on the optical axis of the aspheric surface).

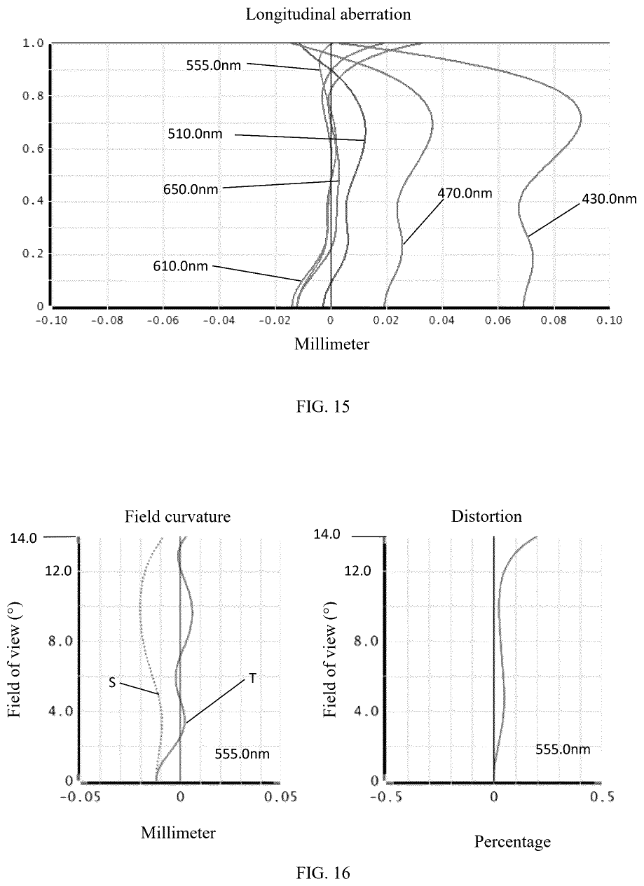

FIG. 14 and FIG. 15 schematically illustrate a lateral color and a longitudinal aberration of the camera optical lens 40 in the first state according to the Fourth Embodiment after light with wavelengths of 650 nm, 610 nm, 555 nm, 510 nm, 470 nm, and 430 nm passing through the camera optical lens 40, respectively. FIG. 16 schematically illustrates a field curvature and a distortion of the camera optical lens 40 in the first state after light with a wavelength of 555 nm passing through the camera optical lens 40 according to the Fourth Embodiment. A field curvature S in FIG. 16 is a field curvature in a sagittal direction, and Tis a field curvature in a tangential direction.

It can be derived, according to Table 37, that the Fourth Embodiment satisfies the conditions.

In the embodiment, an entrance pupil diameter (ENPD) of the camera optical lens 40 in the first state is 7.259 mm, an image height IH of 1.0H is 3.600 mm, and a diagonal field of view FOV is 27.99°. Thus, the camera optical lens 40 can meet the design requirements of long focal length, large aperture, and miniaturization, and on-axis and off-axis chromatic aberrations of the camera optical lens 40 can be completely corrected, thereby having excellent optical characteristics.

### Fifth Embodiment

The symbols in the Fifth Embodiment have the same meanings as those in the First Embodiment. In the following, only the differences are illustrated.

The Fifth Embodiment differs from the First Embodiment in that in the Fifth Embodiment, the object side surface of the fifth lens L5 is concave in the paraxial region, and the image side surface of the fifth lens L5 is convex in the paraxial region.

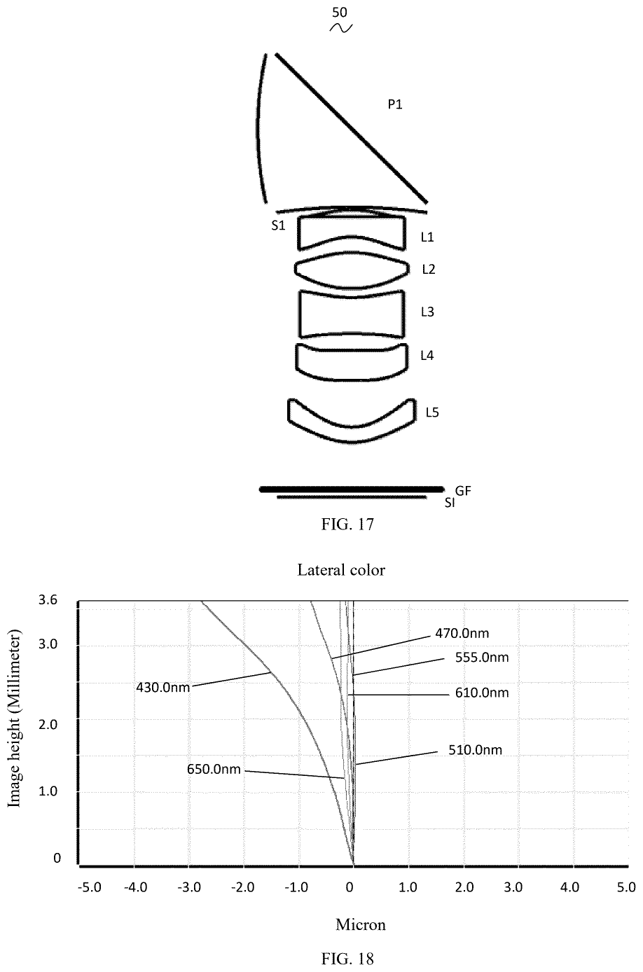

The camera optical lens 50 according to the Fifth Embodiment is shown in FIG. 17.

Table 13 shows design data of the camera optical lens 50 according to the Fifth Embodiment of the present disclosure.

TABLE 13

| | R | d | | nd | | vd | |
|---|---|---|---|---|---|---|---|
| S1 | ∞ | d0= | −10.048 | | | | |
| Rp1 | 19.771 | dp1= | 9.500 | nd1 | 1.8052 | vd1 | 40.91 |
| Rp2 | 28.284 | dp2= | 0.156 | | | | |
| R1 | 5.466 | d1= | 1.494 | nd2 | 1.6400 | vd2 | 23.54 |
| R2 | 3.427 | d2= | 0.866 | | | | |
| R3 | 5.180 | d3= | 2.000 | nd3 | 1.5444 | vd3 | 55.82 |
| R4 | −5.772 | d4= | d4 | | | | |
| R5 | −6.085 | d5= | 2.000 | nd4 | 1.6153 | vd4 | 25.94 |
| R6 | 31.426 | d6= | 0.912 | | | | |
| R7 | 18.966 | d7= | 1.690 | nd5 | 1.6700 | vd5 | 19.39 |
| R8 | −25.454 | d8= | 2.577 | | | | |
| R9 | −2.771 | d9= | 0.845 | nd6 | 1.5346 | vd6 | 55.69 |
| R10 | −3.879 | d10= | d10 | | | | |
| R11 | ∞ | d11= | 0.210 | ndg | 1.5168 | vdg | 64.17 |
| R12 | ∞ | d12= | 0.320 | | | | |

Herein, dp1 is a sum of “dp1-01” and “dp1-02”, a value of “dp1-01” is 5.000, and a value of “dp1-02” is 4.500.

Table 14 shows the values of the relevant optical parameters of the camera optical lens 50, in the first state and the second state respectively, in the Fifth Embodiment of the present disclosure.

TABLE 14

| | First state | Second state |
|---|---|---|
| fA | 16.560 | 15.610 |
| FOV | 24.31° | 23.80° |
| FNO | 2.318 | 2.610 |
| d4 | 0.504 | 1.125 |
| d10 | 2.502 | 1.881 |

Table 15 shows aspherical surface data of each lens of the camera optical lens 50 in the Fifth Embodiment of the present disclosure.

TABLE 15

| | Conic | | | | | |
|---|---|---|---|---|---|---|
| | coefficient | Aspheric surface coefficients | | | | |
| | k | A4 | A6 | A8 | A10 | A12 |
| Rp1 | — | 9.01460E−05 | 1.20880E−06 | −1.11760E− | 5.49060E−09 | 4.14740E−11 |
| Rp2 | 0.00000E+00 | 0.00000E+00 | 0.00000E+00 | 0.00000E+00 | 0.00000E+00 | 0.00000E+00 |
| R1 | — | −1.98890E− | −2.69790E− | 1.88660E−06 | 1.98780E−05 | −1.19760E− |
| R2 | −8.11736E− | −7.42500E− | −4.29440E− | 2.04550E−04 | −8.47050E− | 2.65370E−05 |
| R3 | — | 6.76340E−03 | −2.20600E− | 4.90380E−04 | −9.75970E− | 1.54250E−05 |
| R4 | 4.60950E−01 | 4.55410E−04 | −3.59640E− | 1.96820E−04 | −6.99000E− | 1.68150E−05 |
| R5 | — | −7.66150E− | 4.06470E−03 | −1.33290E− | 3.19260E−04 | −5.37730E− |
| R6 | 7.66143E+01 | 3.14890E−03 | −1.16470E− | 1.79460E−03 | −1.94230E− | 1.43190E−03 |
| R7 | 4.79558E+01 | −9.76790E− | −2.58730E− | 6.10490E−04 | −1.18520E− | 1.50110E−03 |
| R8 | 6.14216E+01 | −6.83680E− | 9.39720E−05 | 1.16420E−04 | −6.35860E− | 2.32960E−05 |
| R9 | — | −4.43570E− | 1.97370E−03 | −9.83060E− | 5.04450E−04 | −1.67700E− |
| R10 | −8.42688E− | 5.44740E−03 | −8.30080E− | 9.50760E−03 | −6.54490E− | 3.00610E−03 |
| | Conic | | | | | |
| | coefficient | Aspheric surface coefficients | | | | |
| | k | A14 | A16 | A18 | A20 | A22 |
| Rp1 | — | −1.35570E− | 5.50870E−13 | −9.78940E− | 6.71150E−17 | 0.00E+00 |
| Rp2 | 0.00000E+00 | 0.00000E+00 | 0.00000E+00 | 0.00000E+00 | 0.00000E+00 | 0.00E+00 |
| R1 | — | 3.57840E−06 | −6.26440E− | 6.48900E−08 | −3.69210E− | 8.91E−11 |
| R2 | −8.11736E− | −5.66890E− | 8.04280E−07 | −7.27990E− | 3.81360E−09 | −8.81E−11 |
| R3 | — | −1.64880E− | 1.06540E−07 | −3.56350E− | 4.66920E−11 | 0.00E+00 |
| R4 | 4.60950E−01 | −2.59610E− | 2.48210E−07 | −1.34390E− | 3.21150E−10 | 0.00E+00 |
| R5 | — | 6.02950E−06 | −4.19890E− | 1.62150E−08 | −2.63540E− | 0.00E+00 |
| R6 | 7.66143E+01 | −7.52120E− | 2.86840E−04 | −8.01790E− | 1.64150E−05 | −2.43E−06 |
| R7 | 4.79558E+01 | −1.23630E− | 6.80280E−04 | −2.57470E− | 6.80460E−05 | −1.25E−05 |
| R8 | 6.14216E+01 | −6.06120E− | 1.09020E−06 | −1.27850E− | 9.06390E−09 | −3.43E−10 |
| R9 | — | 3.52770E−05 | −4.73220E− | 3.98570E−07 | −2.01230E− | 5.48E−10 |
| R10 | −8.42688E− | −9.60680E− | 2.18940E−04 | −3.60500E− | 4.29770E−06 | −3.67E−07 |

| | Conic | | | | |
|---|---|---|---|---|---|
| | coefficient | Aspheric surface coefficients | | | |
| | k | A24 | A26 | A28 | A30 |
| Rp1 | — | 0.00E+00 | 0.00E+00 | 0.00E+00 | 0.00E+00 |
| Rp2 | 0.00000E+00 | 0.00E+00 | 0.00E+00 | 0.00E+00 | 0.00E+00 |
| R1 | — | 0.00E+00 | 0.00E+00 | 0.00E+00 | 0.00E+00 |
| R2 | −8.11736E− | 0.00E+00 | 0.00E+00 | 0.00E+00 | 0.00E+00 |
| R3 | — | 0.00E+00 | 0.00E+00 | 0.00E+00 | 0.00E+00 |
| R4 | 4.60950E−01 | 0.00E+00 | 0.00E+00 | 0.00E+00 | 0.00E+00 |
| R5 | — | 0.00E+00 | 0.00E+00 | 0.00E+00 | 0.00E+00 |
| R6 | 7.66143E+01 | 2.52E−07 | −1.74E−08 | 7.13E−10 | −1.31E−11 |
| R7 | 4.79558E+01 | 1.58E−06 | −1.30E−07 | 6.32E−09 | −1.37E−10 |
| R8 | 6.14216E+01 | 5.09E−12 | 0.00E+00 | 0.00E+00 | 0.00E+00 |
| R9 | — | −6.06E−12 | 0.00E+00 | 0.00E+00 | 0.00E+00 |
| R10 | −8.42688E− | 2.19E−08 | −8.67E−10 | 2.04E−11 | −2.17E−13 |

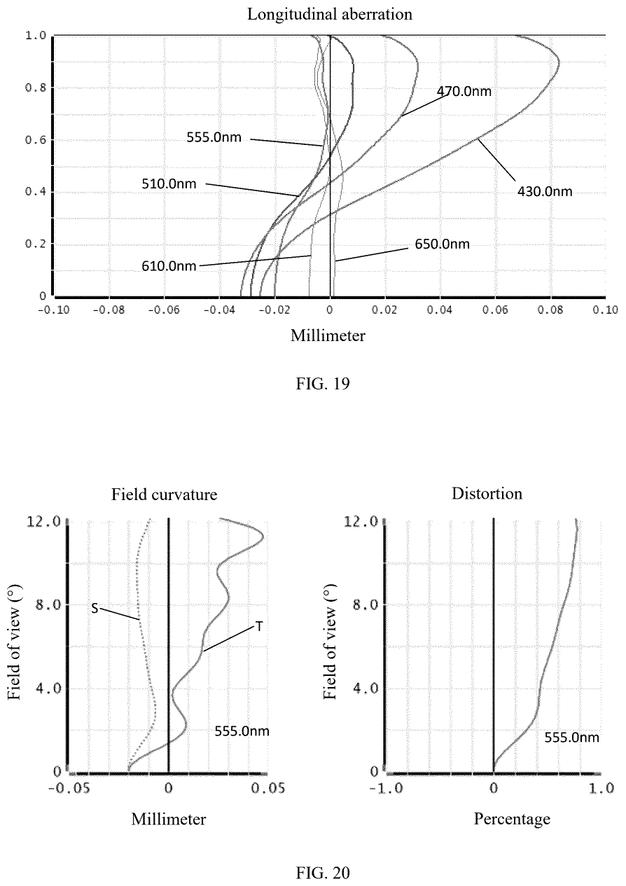

FIG. 18 and FIG. 19 schematically illustrate a lateral color and a longitudinal aberration of the camera optical lens 50 in the first state according to the Fifth Embodiment after light with wavelengths of 650 nm, 610 nm, 555 nm, 510 nm, 470 nm, and 430 nm passing through the camera optical lens 50, respectively. FIG. 20 schematically illustrates a field curvature and a distortion of the camera optical lens 50 in the first state after light with a wavelength of 555 nm passing through the camera optical lens 50 according to the Fifth Embodiment. A field curvature S in FIG. 20 is a field curvature in a sagittal direction, and Tis a field curvature in a tangential direction.

It can be derived, according to Table 37, that the Fifth Embodiment satisfies the conditions.

In the embodiment, an entrance pupil diameter (ENPD) of the camera optical lens 50 in the first state is 7.143 mm, an image height IH of 1.0H is 3.600 mm, and a diagonal field of view FOV is 24.31°. Thus, the camera optical lens 50 can meet the design requirements of long focal length, large aperture, and miniaturization, and on-axis and off-axis chromatic aberrations of the camera optical lens 50 can be completely corrected, thereby having excellent optical characteristics.

### Sixth Embodiment

The symbols in the Sixth Embodiment have the same meanings as those in the First Embodiment. In the following, only the differences are illustrated.

The Sixth Embodiment differs from the First Embodiment in that in the Sixth Embodiment, the image side surface of the fourth lens L4 is concave in the paraxial region, the object side surface of the fifth lens L5 is concave in the paraxial region, the image side surface of the fifth lens L5 is convex in the paraxial region, and the fifth lens L5 has a positive refractive power.

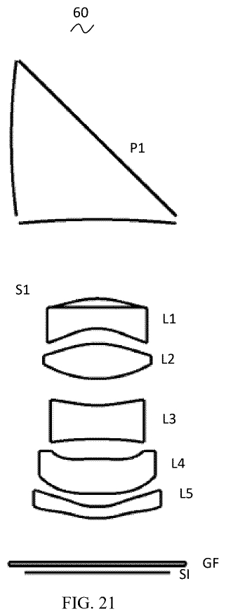

The camera optical lens 60 according to the Sixth Embodiment is shown in FIG. 21.

Table 16 shows design data of the camera optical lens 60 according to the Sixth Embodiment of the present disclosure.

TABLE 16

| | R | d | | nd | | vd | |
|---|---|---|---|---|---|---|---|
| S1 | ∞ | d0= | −14.521 | | | | |
| Rp1 | 36.036 | dp1= | 9.500 | nd1 | 1.8052 | vd1 | 40.91 |
| Rp2 | 45.045 | dp2= | 4.522 | | | | |
| R1 | 4.855 | d1= | 1.699 | nd2 | 1.6400 | vd2 | 23.54 |
| R2 | 2.981 | d2= | 0.870 | | | | |
| R3 | 4.635 | d3= | 2.000 | nd3 | 1.5444 | vd3 | 55.82 |
| R4 | −5.780 | d4= | 1.518 | | | | |
| R5 | −6.338 | d5= | 1.934 | nd4 | 1.6153 | vd4 | 25.94 |
| R6 | 26.362 | d6= | 1.127 | | | | |
| R7 | 12.084 | d7= | 1.986 | nd5 | 1.6700 | vd5 | 19.39 |
| R8 | 27.802 | d8= | 0.750 | | | | |
| R9 | −5.196 | d9= | 0.662 | nd6 | 1.5346 | vd6 | 55.69 |
| R10 | −5.372 | d10= | 2.502 | | | | |
| R11 | ∞ | d11= | 0.210 | ndg | 1.5168 | vdg | 64.17 |
| R12 | ∞ | d12= | 0.402 | | | | |

Herein, dp1 is a sum of “dp1-01” and “dp1-02”, a value of “dp1-01” is 5.000, and a value of “dp1-02” is 4.500.

Table 17 shows the values of the relevant optical parameters of the camera optical lens 60, in the first state and the second state respectively, in the Sixth Embodiment of the present disclosure.

TABLE 17

| | First state | Second state |
|---|---|---|
| fA | 14.689 | 13.890 |
| FOV | 26.99° | 26.02° |
| FNO | 2.318 | 2.611 |
| d4 | 1.518 | 2.011 |
| d10 | 2.502 | 2.009 |

Table 18 shows aspherical surface data of each lens of the camera optical lens 60 in the Sixth Embodiment of the present disclosure.

TABLE 18

| | Conic | | | | | |
|---|---|---|---|---|---|---|
| | coefficient | Aspheric surface coefficients | | | | |
| | k | A4 | A6 | A8 | A10 | A12 |
| Rp1 | — | 4.58160E−05 | −5.04340E− | −1.46430E− | 7.31570E−10 | −1.42090E− |
| Rp2 | 0.00000E+00 | 0.00000E+00 | 0.00000E+00 | 0.00000E+00 | 0.00000E+00 | 0.00000E+0 |
| R1 | — | −1.73070E− | −2.17580E− | 2.64250E−05 | −7.60420E− | 7.75420E−07 |
| R2 | −9.02107E− | −8.81570E− | −8.68900E− | 1.21180E−04 | −7.61100E− | 2.79840E−05 |
| R3 | — | 7.38270E−03 | −2.23570E− | 5.18790E−04 | −1.15810E− | 2.00050E−05 |
| R4 | 3.71952E−01 | 5.20560E−04 | −4.53150E− | 4.14150E−05 | −2.45790E− | 7.97290E−06 |
| R5 | — | −6.24710E− | 3.95240E−03 | −1.44510E− | 3.87830E−04 | −7.28570E− |
| R6 | 9.83329E+01 | −2.62770E− | 3.62510E−03 | −2.86490E− | 2.31320E−03 | −1.55790E− |
| R7 | 1.89999E+01 | −2.01500E− | −1.55330E− | 9.92970E−03 | −1.49340E− | 1.41320E−02 |
| R8 | 5.18114E+01 | −3.68210E− | 9.43020E−03 | −2.15190E− | 5.62000E−04 | −1.27200E− |
| R9 | — | −5.66080E− | 1.79320E−02 | 2.48820E−03 | −2.66320E− | 7.58520E−04 |
| R10 | — | −2.13880E− | 4.82030E−03 | 4.97630E−03 | −3.43250E− | 1.22190E−03 |
| | Conic | | | | | |
| | coefficient | Aspheric surface coefficients | | | | |
| | k | A14 | A16 | A18 | A20 | A22 |
| Rp1 | — | 1.41360E−13 | −7.70130E− | 2.19430E−18 | −2.56430E− | 0.00E+00 |
| Rp2 | 0.00000E+00 | 0.00000E+00 | 0.00000E+00 | 0.00000E+00 | 0.00000E+00 | 0.00E+00 |
| R1 | — | 1.93510E−07 | −8.23540E− | 1.28320E−08 | −9.72320E− | 2.96E−11 |
| R2 | −9.02107E− | −6.51580E− | 9.81690E−07 | −9.28200E− | 5.04350E−09 | −1.21E−10 |
| R3 | — | −2.40360E− | 1.81920E−07 | −7.28220E− | 1.13610E−10 | 0.00E+00 |
| R4 | 3.71952E−01 | −1.55990E− | 1.83490E−07 | −1.19400E− | 3.40250E−10 | 0.00E+00 |
| R5 | — | 9.06950E−06 | −6.96340E− | 2.94370E−08 | −5.21120E− | 0.00E+00 |
| R6 | 9.83329E+01 | 7.55990E−04 | −2.58340E− | 6.24570E−05 | −1.07170E− | 1.30E−06 |
| R7 | 1.89999E+01 | −9.30260E− | 4.36800E−03 | −1.47740E− | 3.59810E−04 | −6.24E−05 |
| R8 | 5.18114E+01 | 1.46110E−05 | 2.46830E−07 | −2.83100E− | 3.40870E−08 | −1.80E−09 |
| R9 | — | −1.24170E− | 1.31460E−05 | −9.16800E− | 4.06920E−08 | −1.04E−09 |
| R10 | — | −3.08600E− | 5.86760E−05 | −8.36720E− | 8.78340E−07 | −6.63E−08 |

| | Conic | | | | |
|---|---|---|---|---|---|
| | coefficient | Aspheric surface coefficients | | | |
| | k | A24 | A26 | A28 | A30 |
| Rp1 | — | 0.00E+00 | 0.00E+00 | 0.00E+00 | 0.00E+00 |
| Rp2 | 0.00000E+00 | 0.00E+00 | 0.00E+00 | 0.00E+00 | 0.00E+00 |
| R1 | — | 0.00E+00 | 0.00E+00 | 0.00E+00 | 0.00E+00 |
| R2 | −9.02107E− | 0.00E+00 | 0.00E+00 | 0.00E+00 | 0.00E+00 |
| R3 | — | 0.00E+00 | 0.00E+00 | 0.00E+00 | 0.00E+00 |
| R4 | 3.71952E−01 | 0.00E+00 | 0.00E+00 | 0.00E+00 | 0.00E+00 |
| R5 | — | 0.00E+00 | 0.00E+00 | 0.00E+00 | 0.00E+00 |
| R6 | 9.83329E+01 | −1.08E−07 | 5.85E−09 | −1.86E−10 | 2.63E−12 |
| R7 | 1.89999E+01 | 7.50E−06 | −5.93E−07 | 2.77E−08 | −5.79E−10 |
| R8 | 5.18114E+01 | 3.67E−11 | 0.00E+00 | 0.00E+00 | 0.00E+00 |
| R9 | — | 1.15E−11 | 0.00E+00 | 0.00E+00 | 0.00E+00 |
| R10 | — | 3.48E−09 | −1.20E−10 | 2.45E−12 | −2.23E−14 |

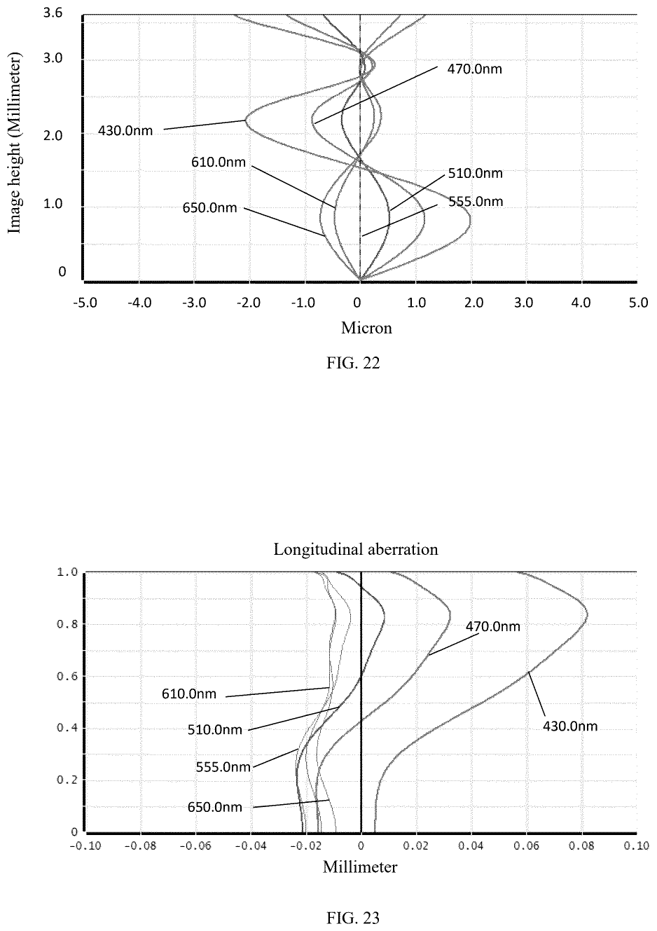

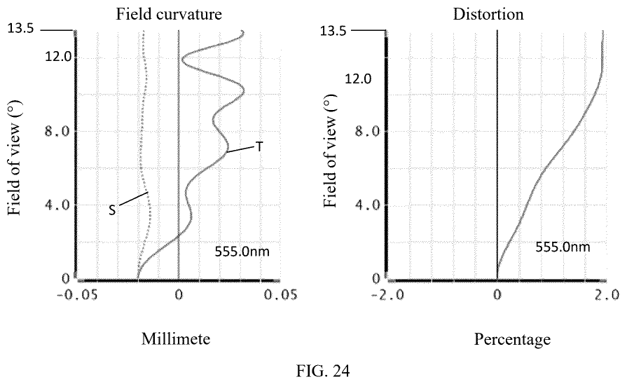

FIG. 22 and FIG. 23 schematically illustrate a lateral color and a longitudinal aberration of the camera optical lens 60 in the first state according to the Sixth Embodiment after light with wavelengths of 650 nm, 610 nm, 555 nm, 510 nm, 470 nm, and 430 nm passing through the camera optical lens 60, respectively. FIG. 24 schematically illustrates a field curvature and a distortion of the camera optical lens 60 in the first state after light with a wavelength of 555 nm passing through the camera optical lens 60 according to the Sixth Embodiment. A field curvature S in FIG. 24 is a field curvature in a sagittal direction, and T is a field curvature in a tangential direction.

It can be derived, according to Table 37, that the Sixth Embodiment satisfies the conditions.

In the embodiment, an entrance pupil diameter (ENPD) of the camera optical lens 60 in the first state is 6.336 mm, an image height IH of 1.0H is 3.600 mm, and a diagonal field of view FOV is 26.99°. Thus, the camera optical lens 60 can meet the design requirements of long focal length, large aperture, and miniaturization, and on-axis and off-axis chromatic aberrations of the camera optical lens 60 can be completely corrected, thereby having excellent optical characteristics.

### Seventh Embodiment

The symbols in the Seventh Embodiment have the same meanings as those in the First Embodiment. In the following, only the differences are illustrated.

The Seventh Embodiment differs from the First Embodiment in that in the Seventh Embodiment, the image side surface of the first prism P1 is planar in the paraxial region, the object side surface of the third lens L3 is convex in the paraxial region, the image side surface of the fourth lens L4 is concave in the paraxial region, and the object side surface of the fifth lens L5 is concave in the paraxial region.

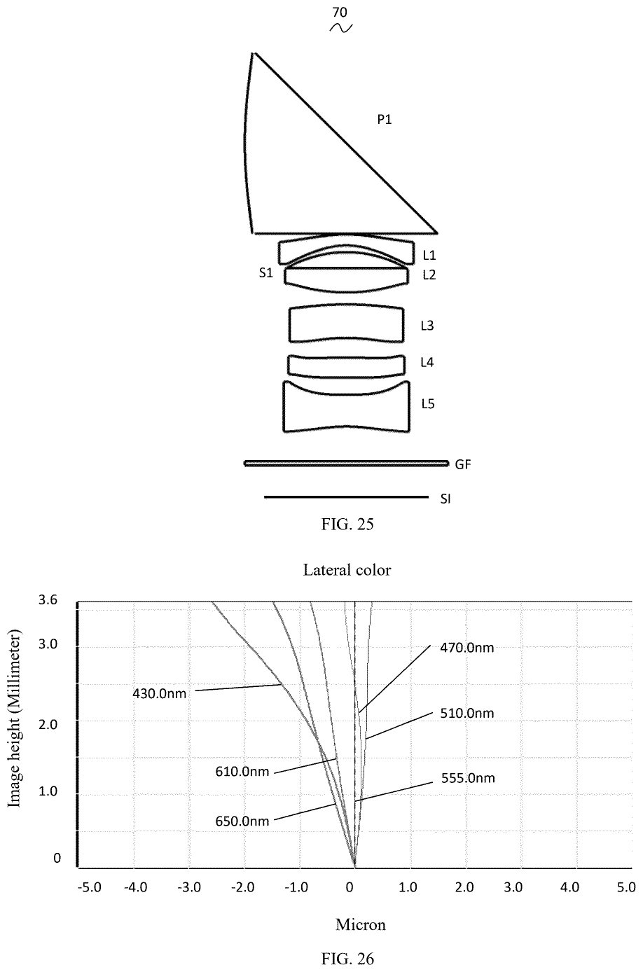

The camera optical lens 70 according to the Seventh Embodiment is shown in FIG. 25.

Table 19 shows design data of the camera optical lens 70 according to the Seventh Embodiment of the present disclosure.

TABLE 19

| | R | d | | nd | | vd | |
|---|---|---|---|---|---|---|---|
| S1 | ∞ | d0= | −9.500 | | | | |
| Rp1 | 21.336 | dp1= | 9.500 | nd1 | 1.8052 | vd1 | 40.91 |
| Rp2 | ∞ | dp2= | 0.030 | | | | |
| R1 | 6.916 | d1= | 0.545 | nd2 | 1.6400 | vd2 | 23.54 |
| R2 | 3.423 | d2= | 0.338 | | | | |
| R3 | 5.489 | d3= | 2.000 | nd3 | 1.5444 | vd3 | 55.82 |
| R4 | −8.410 | d4= | d4 | | | | |
| R5 | 15.376 | d5= | 1.667 | nd4 | 1.6153 | vd4 | 25.94 |
| R6 | 8.333 | d6= | 0.970 | | | | |
| R7 | 19.329 | d7= | 1.000 | nd5 | 1.6700 | vd5 | 19.39 |
| R8 | 77.802 | d8= | 0.853 | | | | |
| R9 | −39.832 | d9= | 1.577 | nd6 | 1.5346 | vd6 | 55.69 |
| R10 | 7.106 | d10= | d10 | | | | |
| R11 | ∞ | d11= | 0.210 | ndg | 1.5168 | vdg | 64.17 |
| R12 | ∞ | d12= | 1.572 | | | | |

Herein, dp1 is a sum of “dp1-01” and “dp1-02”, a value of “dp1-01” is 5.000, and a value of “dp1-02” is 4.500.

Table 20 shows the values of the relevant optical parameters of the camera optical lens 70, in the first state and the second state respectively, in the Seventh Embodiment of the present disclosure.

TABLE 20

| | First state | Second state |
|---|---|---|
| fA | 14.472 | 13.761 |
| FOV | 27.60° | 26.85° |
| FNO | 1.983 | 2.340 |
| d4 | 0.595 | 1.192 |
| d10 | 1.719 | 1.122 |

Table 21 shows aspherical surface data of each lens of the camera optical lens 70 in the Seventh Embodiment of the present disclosure.

TABLE 21

| | Conic | | | | | |
|---|---|---|---|---|---|---|
| | coefficient | Aspheric surface coefficients | | | | |
| | k | A4 | A6 | A8 | A10 | A12 |
| Rp1 | — | 2.00090E−05 | −6.00590E− | 3.11680E−08 | 7.52560E−10 | −5.58430E− |
| Rp2 | 0.00000E+00 | 0.00000E+00 | 0.00000E+00 | 0.00000E+00 | 0.00000E+00 | 0.00000E+00 |
| R1 | 2.51281E−01 | −8.00870E− | 7.83600E−04 | −3.28060E− | −8.00440E− | 1.94190E−06 |
| R2 | −4.92026E− | −1.04700E− | 8.94070E−04 | −1.09460E− | 3.77490E−05 | −1.18370E− |
| R3 | — | 9.38290E−03 | −2.08750E− | 4.14270E−04 | −5.24740E− | 3.10750E−06 |
| R4 | 2.06167E+00 | 7.63760E−04 | −3.30320E− | 4.80650E−05 | −2.48270E− | 8.65760E−06 |
| R5 | 1.66364E+01 | −1.20700E− | 7.27720E−05 | −8.35210E− | 3.65200E−05 | −1.10650E− |
| R6 | — | 1.07310E−02 | −5.86190E− | 2.36600E−03 | −8.18490E− | 2.04840E−04 |
| R7 | 4.07523E+01 | −6.53410E− | 7.68080E−04 | −3.42580E− | 8.80710E−05 | −2.05080E− |
| R8 | 9.90000E+01 | −8.59510E− | 1.39320E−03 | −1.78420E− | −2.53650E− | 2.13660E−05 |
| R9 | −3.61081E− | −1.59680E− | 1.64700E−03 | −9.62120E− | −1.11530E− | 4.70610E−06 |
| R10 | — | −8.25350E− | 1.08130E−03 | −9.89810E− | 3.70940E−06 | 4.84230E−07 |
| | Conic | | | | | |
| | coefficient | Aspheric surface coefficients | | | | |
| | k | A14 | A16 | A18 | A20 | A22 |
| Rp1 | — | −8.96200E− | 3.93790E−14 | 1.49300E−15 | −4.87940E− | |
| Rp2 | 0.00000E+00 | 0.00000E+00 | 0.00000E+00 | 0.00000E+00 | 0.00000E+00 | |
| R1 | 2.51281E−01 | −2.26540E− | 1.61030E−08 | −6.68700E− | 1.24750E−11 | |
| R2 | −4.92026E− | 2.11560E−06 | −2.13370E− | 1.12910E−08 | −2.42740E− | |
| R3 | — | 1.29650E−07 | −2.99250E− | 1.20250E−09 | 6.07350E−12 | |
| R4 | 2.06167E+00 | −1.83080E− | 2.32430E−07 | −1.61930E− | 4.81290E−10 | |
| R5 | 1.66364E+01 | 2.10770E−06 | −2.43480E− | 1.54810E−08 | −4.00870E− | |
| R6 | — | −3.53590E− | 3.96620E−06 | −2.57940E− | 7.39200E−09 | |
| R7 | 4.07523E+01 | 3.23660E−06 | −3.40320E− | 2.75310E−08 | −1.14690E− | |
| R8 | 9.90000E+01 | −5.99400E− | 9.28350E−07 | −7.57320E− | 2.57050E−09 | |
| R9 | −3.61081E− | −8.41760E− | 8.85000E−08 | −5.15650E− | 1.12980E−10 | |
| R10 | — | −9.02450E− | 6.45220E−09 | −2.27960E− | 3.24080E−12 | |

In the Seventh Embodiment, an aspheric surface of each lens surface of the camera optical lens 70 uses a respective aspheric surface as expressed in the following condition (2).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 2 )$$

Herein, k is a conic coefficient, A4, A6, A8, A10, A12, A14, A16, A18, and A20 are aspheric surface coefficients, c is a central curvature of an optical surface, r is a vertical distance between a point on an aspheric curve and the optical axis, and z is a depth of the aspheric surface (the vertical distance between a point on the aspheric surface from which a vertical distance to the optical axis is r and a tangent plane tangent to a vertex on the optical axis of the aspheric surface).

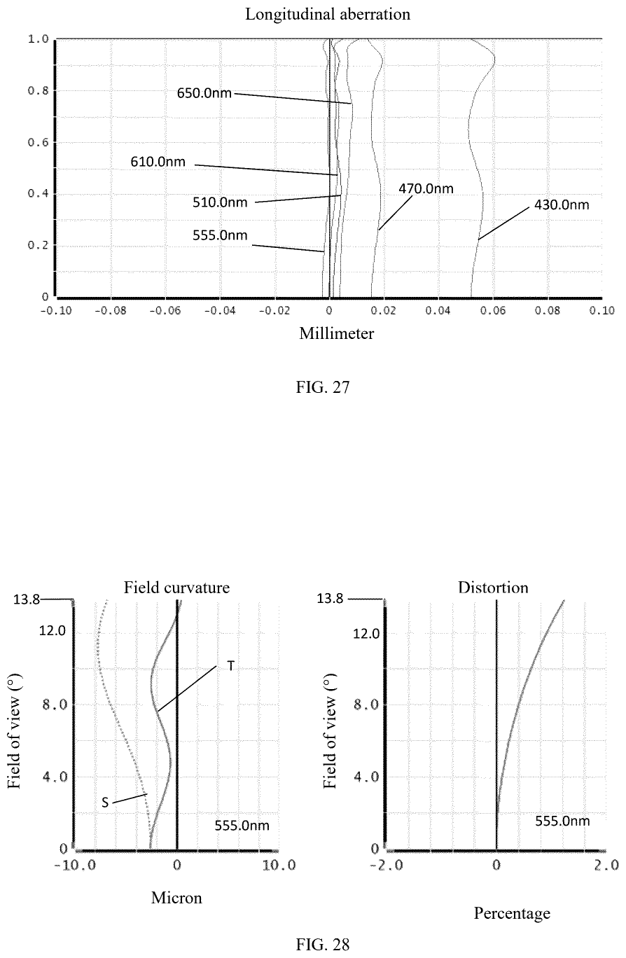

FIG. 26 and FIG. 27 schematically illustrate a lateral color and a longitudinal aberration of the camera optical lens 70 in the first state according to the Seventh Embodiment after light with wavelengths of 650 nm, 610 nm, 555 nm, 510 nm, 470 nm, and 430 nm passing through the camera optical lens 70, respectively. FIG. 28 schematically illustrates a field curvature and a distortion of the camera optical lens 70 in the first state after light with a wavelength of 555 nm passing through the camera optical lens 70 according to the Seventh Embodiment. A field curvature S in FIG. 28 is a field curvature in a sagittal direction, and Tis a field curvature in a tangential direction.

It can be derived, according to Table 37, that the Seventh Embodiment satisfies the conditions.

In the embodiment, an entrance pupil diameter (ENPD) of the camera optical lens 70 in the first state is 7.297 mm, an image height IH of 1.0H is 3.600 mm, and a diagonal field of view FOV is 27.60°. Thus, the camera optical lens 70 can meet the design requirements of long focal length, large aperture, and miniaturization, and on-axis and off-axis chromatic aberrations of the camera optical lens 70 can be completely corrected, thereby having excellent optical characteristics.

### Eighth Embodiment

The symbols in the Eighth Embodiment have the same meanings as those in the First Embodiment. In the following, only the differences are illustrated.

The Eighth Embodiment differs from the First Embodiment in that in the Eighth Embodiment, the image side surface of the first prism P1 is convex in the paraxial region, the object side surface of the third lens L3 is convex in the paraxial region, the image side surface of the fourth lens L4 is concave in the paraxial region, the object side surface of the fifth lens L5 is concave in the paraxial region, and the image side surface of the fifth lens L5 is convex in the paraxial region.

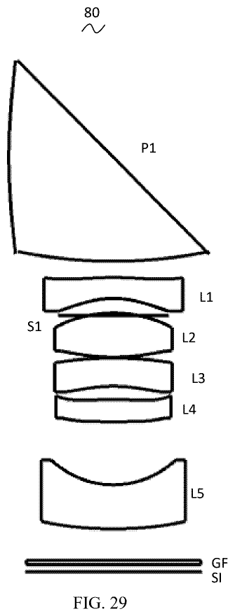

The camera optical lens 80 according to the Eighth Embodiment is shown in FIG. 29.

Table 22 shows design data of the camera optical lens 80 according to the Eighth Embodiment of the present disclosure.

TABLE 22

| | R | d | | nd | | vd | |
|---|---|---|---|---|---|---|---|
| S1 | ∞ | d0= | −11.961 | | | | |
| Rp1 | 26.338 | dp1= | 9.500 | nd1 | 1.8052 | vd1 | 40.91 |
| Rp2 | −22.040 | dp2= | 0.736 | | | | |
| R1 | 13.083 | d1= | 0.942 | nd2 | 1.6400 | vd2 | 23.54 |
| R2 | 3.971 | d2= | 0.660 | | | | |
| R3 | 5.666 | d3= | 2.000 | nd3 | 1.5444 | vd3 | 55.82 |
| R4 | −8.834 | d4= | d4 | | | | |
| R5 | 14.766 | d5= | 1.290 | nd4 | 1.6153 | vd4 | 25.94 |
| R6 | 6.671 | d6= | 0.602 | | | | |
| R7 | 15.214 | d7= | 1.000 | nd5 | 1.6700 | vd5 | 19.39 |
| R8 | 319.430 | d8= | 2.854 | | | | |
| R9 | −4.323 | d9= | 2.000 | nd6 | 1.5346 | vd6 | 55.69 |
| R10 | −20.210 | d10= | d10 | | | | |
| R11 | ∞ | d11= | 0.210 | ndg | 1.5168 | vdg | 64.17 |
| R12 | ∞ | d12= | 0.308 | | | | |

Herein, dp1 is a sum of “dp1-01” and “dp1-02”, a value of “dp1-01” is 5.000, and a value of “dp1-02” is 4.500.

Table 23 shows the values of the relevant optical parameters of the camera optical lens 80, in the first state and the second state respectively, in the Eighth Embodiment of the present disclosure.

TABLE 23

| | First state | Second state |
|---|---|---|
| fA | 14.396 | 13.711 |
| FOV | 28.05° | 27.20° |
| FNO | 1.983 | 2.354 |
| d4 | 0.030 | 0.637 |
| d10 | 1.419 | 0.812 |

Table 24 shows aspherical surface data of each lens of the camera optical lens 80 in the Eighth Embodiment of the present disclosure.

TABLE 24

| | Conic | | | | | |
|---|---|---|---|---|---|---|
| | coefficient | Aspheric surface coefficients | | | | |
| | k | A4 | A6 | A8 | A10 | A12 |
| Rp1 | — | 1.69030E−05 | −4.31760E− | 3.80750E−08 | 3.54820E−10 | −3.18920E− |
| Rp2 | 0.00000E+00 | 0.00000E+00 | 0.00000E+00 | 0.00000E+00 | 0.00000E+00 | 0.00000E+00 |
| R1 | 3.50434E+00 | −6.49750E− | 4.18720E−04 | −1.06410E− | −3.69520E− | 7.85200E−07 |
| R2 | −4.31129E− | −9.11390E− | 5.56750E−04 | −2.86160E− | 9.91890E−07 | −7.87280E− |
| R3 | — | 7.92750E−03 | −1.41240E− | 2.96890E−04 | −4.80130E− | 5.92690E−06 |
| R4 | — | 8.41720E−04 | 3.38270E−05 | 3.84550E−05 | −1.27750E− | 3.73830E−06 |
| R5 | 1.54883E+01 | −1.29470E− | 8.52870E−05 | −3.65400E− | 1.63690E−05 | −5.87790E− |
| R6 | — | 1.15710E−02 | −5.91070E− | 2.35720E−03 | −7.91310E− | 1.94990E−04 |
| R7 | 1.17532E+01 | −7.81230E− | −7.13460E− | −9.40590E− | 5.17240E−05 | −1.97160E− |
| R8 | 9.90000E+01 | −5.70530E− | −8.61660E− | 3.49270E−05 | −7.53250E− | 1.41870E−06 |
| R9 | — | −1.80230E− | 3.68710E−03 | −9.99000E− | 2.42820E−04 | −4.53130E− |
| R10 | 2.23826E+01 | −8.13880E− | 8.66070E−05 | −4.50130E− | 5.43080E−07 | −3.29460E− |
| | Conic | | | | | |
| | coefficient | Aspheric surface coefficients | | | | |
| | k | A14 | A16 | A18 | A20 | A22 |
| Rp1 | — | −2.16430E− | 2.15060E−14 | −1.24670E− | −4.87660E− | |
| Rp2 | 0.00000E+00 | 0.00000E+00 | 0.00000E+00 | 0.00000E+00 | 0.00000E+00 | |
| R1 | 3.50434E+00 | −9.23770E− | 6.90680E−09 | −2.98600E− | 5.59100E−12 | |
| R2 | −4.31129E− | 1.97990E−07 | −2.55020E− | 1.72080E−09 | −4.78070E− | |
| R3 | — | −4.74810E− | 1.86430E−08 | 8.71100E−11 | −2.25180E− | |
| R4 | — | −6.85740E− | 8.13590E−08 | −5.64210E− | 1.74510E−10 | |
| R5 | 1.54883E+01 | 1.28390E−06 | −1.64060E− | 1.12630E−08 | −3.25680E− | |
| R6 | — | −3.34960E− | 3.74790E−06 | −2.42540E− | 6.72140E−09 | |
| R7 | 1.17532E+01 | 4.60560E−06 | −6.31430E− | 5.09060E−08 | −2.04850E− | |
| R8 | 9.90000E+01 | −4.76420E− | −9.50130E− | 1.32660E−09 | −7.49020E− | |
| R9 | — | 6.03120E−06 | −5.28590E− | 2.70390E−08 | −6.12340E− | |
| R10 | 2.23826E+01 | 1.17490E−09 | −2.74010E− | 3.51540E−13 | −1.78440E− | |

In the Eighth Embodiment, an aspheric surface of each lens surface of the camera optical lens 80 uses a respective aspheric surface as expressed in the following condition (2).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 2 )$$

Herein, k is a conic coefficient, A4, A6, A8, A10, A12, A14, A16, A18, and A20 are aspheric surface coefficients, c is a central curvature of an optical surface, r is a vertical distance between a point on an aspheric curve and the optical axis, and z is a depth of the aspheric surface (the vertical distance between a point on the aspheric surface from which a vertical distance to the optical axis is r and a tangent plane tangent to a vertex on the optical axis of the aspheric surface).

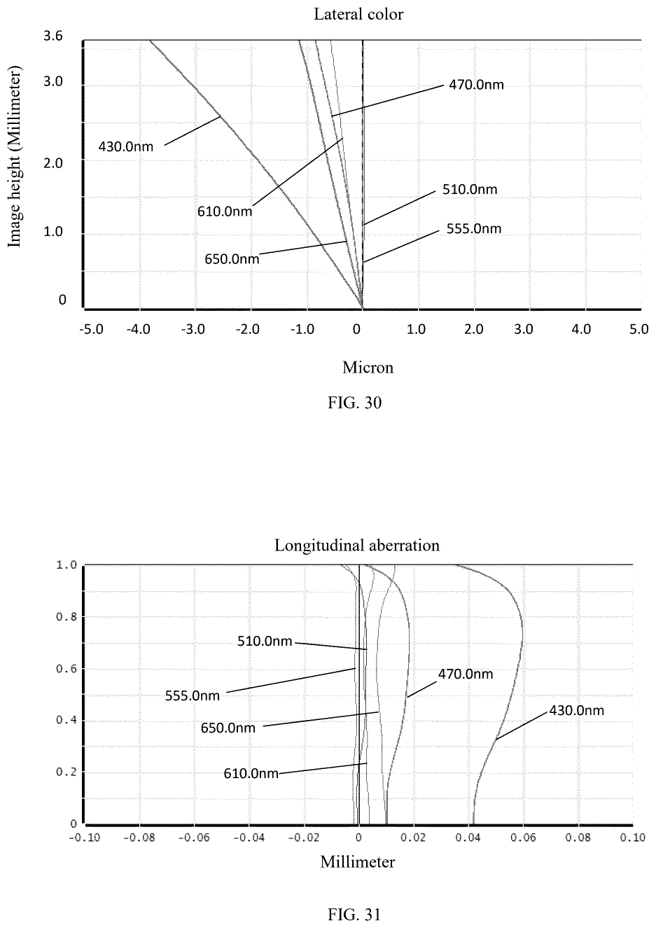

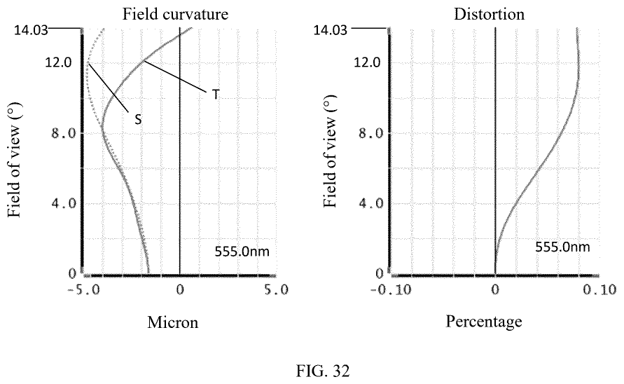

FIG. 30 and FIG. 31 schematically illustrate a lateral color and a longitudinal aberration of the camera optical lens 80 in the first state according to the Eighth Embodiment after light with wavelengths of 650 nm, 610 nm, 555 nm, 510 nm, 470 nm, and 430 nm passing through the camera optical lens 80, respectively. FIG. 32 schematically illustrates a field curvature and a distortion of the camera optical lens 80 in the first state after light with a wavelength of 555 nm passing through the camera optical lens 80 according to the Eighth Embodiment. A field curvature S in FIG. 32 is a field curvature in a sagittal direction, and T is a field curvature in a tangential direction.

It can be derived, according to Table 37, that the Eighth Embodiment satisfies the conditions.

In the embodiment, an entrance pupil diameter (ENPD) of the camera optical lens 80 in the first state is 7.259 mm, an image height IH of 1.0H is 3.600 mm, and a diagonal field of view FOV is 28.05°. Thus, the camera optical lens 80 can meet the design requirements of long focal length, large aperture, and miniaturization, and on-axis and off-axis chromatic aberrations of the camera optical lens 80 can be completely corrected, thereby having excellent optical characteristics.

### Ninth Embodiment

The symbols in the Ninth Embodiment have the same meanings as those in the First Embodiment. In the following, only the differences are illustrated.

The Ninth Embodiment differs from the First Embodiment in that in the Ninth Embodiment, the image side surface of the first prism P1 is convex in the paraxial region, the object side surface of the third lens L3 is convex in the paraxial region, the image side surface of the fourth lens L4 is concave in the paraxial region, the object side surface of the fifth lens L5 is concave in the paraxial region, and the image side surface of the fifth lens L5 is convex in the paraxial region.

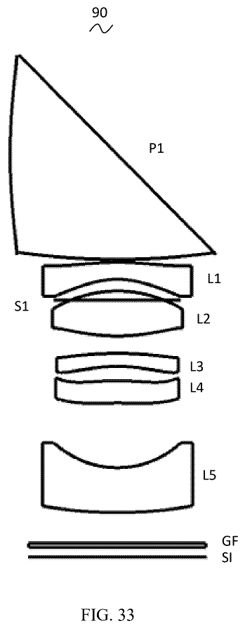

The camera optical lens 90 according to the Ninth Embodiment is shown in FIG. 33.

Table 25 shows design data of the camera optical lens 90 according to the Ninth Embodiment of the present disclosure.

TABLE 25

| | R | d | | nd | | vd | |
|---|---|---|---|---|---|---|---|
| S1 | ∞ | d0= | −11.316 | | | | |
| Rp1 | 23.774 | dp1= | 9.500 | nd1 | 1.8052 | vd1 | 40.91 |
| Rp2 | −32.235 | dp2= | 0.129 | | | | |
| R1 | 10.298 | d1= | 0.764 | nd2 | 1.6400 | vd2 | 23.54 |
| R2 | 3.779 | d2= | 0.528 | | | | |
| R3 | 5.491 | d3= | 2.000 | nd3 | 1.5444 | vd3 | 55.82 |
| R4 | −8.833 | d4= | d4 | | | | |
| R5 | 15.576 | d5= | 0.571 | nd4 | 1.6153 | vd4 | 25.94 |
| R6 | 6.970 | d6= | 0.640 | | | | |
| R7 | 10.879 | d7= | 1.000 | nd5 | 1.6700 | vd5 | 19.39 |
| R8 | 32.636 | d8= | 2.877 | | | | |
| R9 | −4.444 | d9= | 2.000 | nd6 | 1.5346 | vd6 | 55.69 |
| R10 | −24.108 | d10= | d10 | | | | |
| R11 | ∞ | d11= | 0.210 | ndg | 1.5168 | vdg | 64.17 |
| R12 | ∞ | d12= | 0.419 | | | | |

Herein, dp1 is a sum of “dp1-01” and “dp1-02”, a value of “dp1-01” is 5.000, and a value of “dp1-02” is 4.500.

Table 26 shows the values of the relevant optical parameters of the camera optical lens 90, in the first state and the second state respectively, in the Ninth Embodiment of the present disclosure.

TABLE 26

| | First state | Second state |
|---|---|---|
| fA | 14.396 | 13.820 |
| FOV | 28.05° | 27.91° |
| FNO | 1.983 | 2.356 |
| d4 | 0.778 | 1.256 |
| d10 | 1.357 | 0.879 |

Table 27 shows aspherical surface data of each lens of the camera optical lens 90 in the Ninth Embodiment of the present disclosure.

TABLE 27

| | Conic | | | | | |
|---|---|---|---|---|---|---|
| | coefficient | Aspheric surface coefficients | | | | |
| | k | A4 | A6 | A8 | A10 | A12 |
| Rp1 | — | 1.81180E−06 | −5.76030E− | 4.00650E−08 | 3.50800E−10 | −4.14410E− |
| Rp2 | 0.00000E+00 | 0.00000E+00 | 0.00000E+00 | 0.00000E+00 | 0.00000E+00 | 0.00000E+00 |
| R1 | 3.52211E+00 | −6.95760E− | 5.81300E−04 | −2.46440E− | −5.42210E− | 1.32320E−06 |
| R2 | −3.81761E− | −9.63750E− | 7.18260E−04 | −1.85180E− | −9.87970E− | 1.65620E−06 |
| R3 | — | 8.75870E−03 | −1.89400E− | 4.67130E−04 | −9.59510E− | 1.57660E−05 |
| R4 | 6.66520E−01 | 7.83650E−04 | −2.92680E− | 5.53450E−05 | −2.05680E− | 5.81670E−06 |
| R5 | 1.43491E+01 | −1.72700E− | 1.62190E−04 | 7.66960E−06 | −7.41320E− | −5.78480E− |
| R6 | — | 9.93390E−03 | −5.34320E− | 2.21000E−03 | −7.42460E− | 1.79360E−04 |
| R7 | 8.37015E+00 | −7.99430E− | −2.27000E− | −3.02570E− | 3.42640E−05 | −1.78860E− |
| R8 | — | −5.39150E− | −1.93560E− | 3.46620E−05 | 2.92720E−06 | −4.79300E− |
| R9 | — | −1.54310E− | 2.79660E−03 | −7.62160E− | 1.99820E−04 | −4.19070E− |
| R10 | 2.91416E+01 | −6.64640E− | 7.64780E−05 | −5.61060E− | 6.34800E−07 | −3.50340E− |
| | Conic | | | | | |
| | coefficient | Aspheric surface coefficients | | | | |
| | k | A14 | A16 | A18 | A20 | A22 |
| Rp1 | — | −1.49620E− | 2.90510E−14 | 8.85370E−17 | −1.74150E− | |
| Rp2 | 0.00000E+00 | 0.00000E+00 | 0.00000E+00 | 0.00000E+00 | 0.00000E+00 | |
| R1 | 3.52211E+00 | −1.50630E− | 9.88730E−09 | −3.51290E− | 5.20710E−12 | |
| R2 | −3.81761E− | −9.84170E− | −4.97200E− | 9.53480E−10 | −3.44940E− | |
| R3 | — | −1.90070E− | 1.55430E−07 | −7.65600E− | 1.73420E−10 | |
| R4 | 6.66520E−01 | −1.05710E− | 1.23020E−07 | −8.25560E− | 2.44700E−10 | |
| R5 | 1.43491E+01 | 6.75230E−07 | −1.29380E− | 1.07340E−08 | −3.71130E− | |
| R6 | — | −2.99560E− | 3.28900E−06 | −2.12500E− | 5.99430E−09 | |
| R7 | 8.37015E+00 | 4.58510E−06 | −6.08970E− | 4.31710E−08 | −1.42460E− | |
| R8 | — | 1.61050E−06 | −2.45510E− | 1.85770E−08 | −5.75930E− | |
| R9 | — | 6.32000E−06 | −6.22130E− | 3.53400E−08 | −8.75860E− | |
| R10 | 2.91416E+01 | 9.59370E−10 | −1.40970E− | 1.06270E−13 | −3.20520E− | |

In the Ninth Embodiment, an aspheric surface of each lens surface of the camera optical lens 90 uses a respective aspheric surface as expressed in the following condition (2).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 2 )$$

Herein, k is a conic coefficient, A4, A6, A8, A10, A12, A14, A16, A18, and A20 are aspheric surface coefficients, c is a central curvature of an optical surface, r is a vertical distance between a point on an aspheric curve and the optical axis, and z is a depth of the aspheric surface (the vertical distance between a point on the aspheric surface from which a vertical distance to the optical axis is r and a tangent plane tangent to a vertex on the optical axis of the aspheric surface).

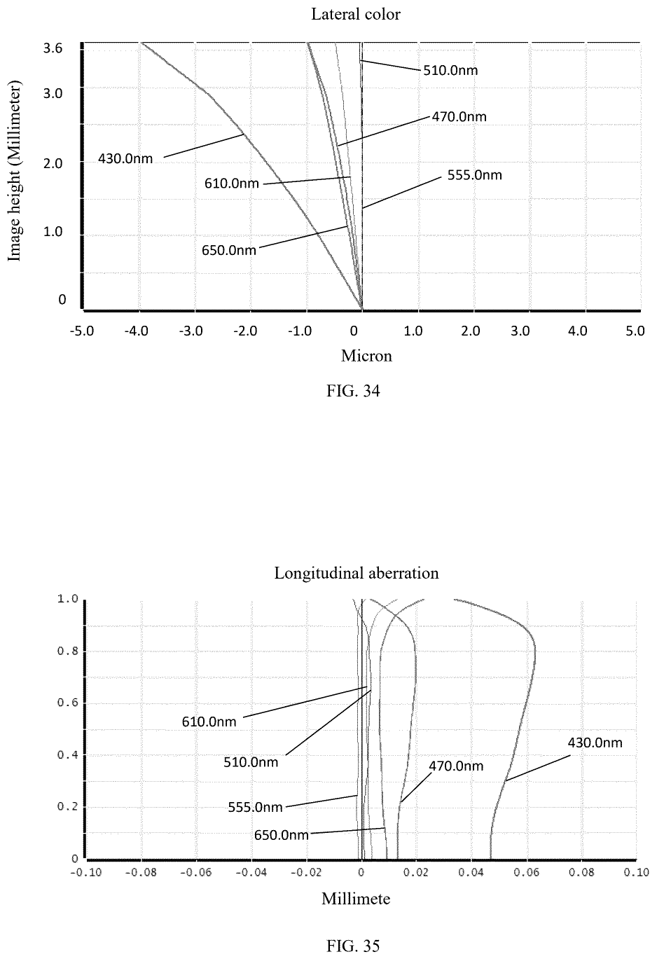

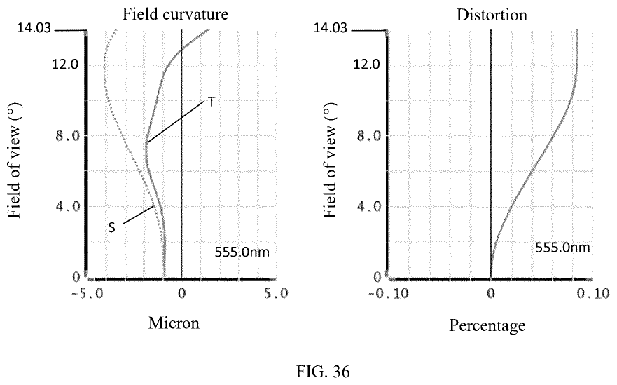

FIG. 34 and FIG. 35 schematically illustrate a lateral color and a longitudinal aberration of the camera optical lens 90 in the first state according to the Ninth Embodiment after light with wavelengths of 650 nm, 610 nm, 555 nm, 510 nm, 470 nm, and 430 nm passing through the camera optical lens 90, respectively. FIG. 36 schematically illustrates a field curvature and a distortion of the camera optical lens 90 in the first state after light with a wavelength of 555 nm passing through the camera optical lens 90 according to the Ninth Embodiment. A field curvature S in FIG. 36 is a field curvature in a sagittal direction, and T is a field curvature in a tangential direction.

It can be derived, according to Table 37, that the Ninth Embodiment satisfies the conditions.

In the embodiment, an entrance pupil diameter (ENPD) of the camera optical lens 90 in the first state is 7.259 mm, an image height IH of 1.0H is 3.600 mm, and a diagonal field of view FOV is 28.05°. Thus, the camera optical lens 90 can meet the design requirements of long focal length, large aperture, and miniaturization, and on-axis and off-axis chromatic aberrations of the camera optical lens 90 can be completely corrected, thereby having excellent optical characteristics.

### Tenth Embodiment

The symbols in the Tenth Embodiment have the same meanings as those in the First Embodiment. In the following, only the differences are illustrated.

The Tenth Embodiment differs from the First Embodiment in that in the Tenth Embodiment, the image side surface of the first prism P1 is convex in the paraxial region, the object side surface of the third lens L3 is convex in the paraxial region, the image side surface of the fourth lens L4 is concave in the paraxial region, the object side surface of the fifth lens L5 is concave in the paraxial region, and the image side surface of the fifth lens L5 is convex in the paraxial region.

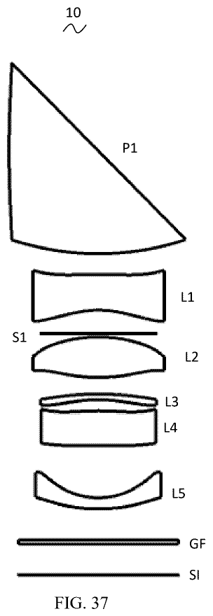

The camera optical lens 100 according to the Tenth Embodiment is shown in FIG. 37.

Table 28 shows design data of the camera optical lens 100 according to the Tenth Embodiment of the present disclosure.

TABLE 28

| | R | d | | nd | | vd | |
|---|---|---|---|---|---|---|---|
| S1 | ∞ | d0= | −13.408 | | | | |
| Rp1 | 55.338 | dp1= | 9.500 | nd1 | 1.8052 | vd1 | 40.91 |
| Rp2 | −13.836 | dp2= | 1.017 | | | | |
| R1 | 23.509 | d1= | 1.743 | nd2 | 1.6400 | vd2 | 23.54 |
| R2 | 4.546 | d2= | 1.323 | | | | |
| R3 | 6.607 | d3= | 2.000 | nd3 | 1.5444 | vd3 | 55.82 |
| R4 | −8.094 | d4= | d4 | | | | |
| R5 | 13.659 | d5= | 0.280 | nd4 | 1.6153 | vd4 | 25.94 |
| R6 | 6.646 | d6= | 0.537 | | | | |
| R7 | 12.592 | d7= | 1.703 | nd5 | 1.6700 | vd5 | 19.39 |
| R8 | 34.490 | d8= | 2.581 | | | | |
| R9 | −3.994 | d9= | 0.533 | nd6 | 1.5346 | vd6 | 55.69 |
| R10 | −10.266 | d10= | d10 | | | | |
| R11 | ∞ | d11= | 0.210 | ndg | 1.5168 | vdg | 64.17 |
| R12 | ∞ | d12= | 1.503 | | | | |

Herein, dp1 is a sum of “dp1-01” and “dp1-02”, a value of “dp1-01” is 5.000, and a value of “dp1-02” is 4.500.

Table 29 shows the values of the relevant optical parameters of the camera optical lens 100, in the first state and the second state respectively, in the Tenth Embodiment of the present disclosure

TABLE 29

| | First state | Second state |
|---|---|---|
| fA | 14.396 | 13.640 |
| FOV | 28.00° | 27.96° |
| FNO | 1.983 | 2.348 |
| d4 | 0.814 | 1.442 |
| d10 | 1.539 | 0.911 |

Table 30 shows aspherical surface data of each lens of the camera optical lens 100 in the Tenth Embodiment of the present disclosure.

TABLE 30

| | Conic | | | | | |
|---|---|---|---|---|---|---|
| | coefficient | Aspheric surface coefficients | | | | |
| | k | A4 | A6 | A8 | A10 | A12 |
| Rp1 | 2.20150E+01 | −1.10780E− | −1.68020E− | 4.65050E−08 | −7.47360E− | 6.96310E−10 |
| Rp2 | 0.00000E+00 | 0.00000E+00 | 0.00000E+00 | 0.00000E+00 | 0.00000E+00 | 0.00000E+00 |
| R1 | 5.37826E+00 | −5.18760E− | 1.01980E−04 | 1.46170E−05 | −3.65910E− | 6.58070E−07 |
| R2 | −3.90429E− | −8.47940E− | 2.46770E−04 | 8.01730E−06 | 1.59910E−06 | −1.27810E− |
| R3 | — | 7.69620E−03 | −1.58930E− | 3.29200E−04 | −4.84570E− | 4.89110E−06 |
| R4 | — | 1.12690E−03 | −1.14170E− | 1.64230E−05 | 5.22050E−06 | −2.58470E− |
| R5 | 1.32019E+01 | −2.72600E− | −2.57780E− | 2.84140E−04 | 1.93970E−05 | −4.48680E− |
| R6 | — | 1.03700E−02 | −7.07470E− | 2.80190E−03 | −6.36610E− | 6.89010E−05 |
| R7 | 1.32048E+01 | −7.79900E− | 7.99550E−05 | −4.34890E− | 3.37170E−04 | −1.21540E− |
| R8 | 9.87027E+01 | −4.97740E− | −5.71780E− | −1.45730E− | 4.88850E−05 | −2.08700E− |
| R9 | — | −1.93120E− | 3.13220E−03 | −9.62310E− | 3.37780E−04 | −8.62410E− |
| R10 | 7.60489E+00 | −3.45370E− | 6.74810E−04 | −1.17420E− | 4.15730E−05 | −9.83420E− |
| | Conic | | | | | |
| | coefficient | Aspheric surface coefficients | | | | |
| | k | A14 | A16 | A18 | A20 | A22 |
| Rp1 | 2.20150E+01 | −3.73000E− | 1.13080E−12 | −1.80960E− | 1.18970E−16 | |
| Rp2 | 0.00000E+00 | 0.00000E+00 | 0.00000E+00 | 0.00000E+00 | 0.00000E+00 | |
| R1 | 5.37826E+00 | −8.84560E− | 7.72230E−09 | −3.81370E− | 7.98740E−12 | |
| R2 | −3.90429E− | 2.56340E−07 | −2.56080E− | 1.26270E−09 | −2.42780E− | |
| R3 | — | −2.54610E− | 9.58110E−10 | 5.54180E−10 | −1.92850E− | |
| R4 | — | 5.41180E−07 | −5.84850E− | 3.45220E−09 | −9.10920E− | |
| R5 | 1.32019E+01 | 1.24010E−05 | −1.58030E− | 1.00790E−07 | −2.66380E− | |
| R6 | — | −1.06790E− | −4.51550E− | 3.75880E−08 | −9.17970E− | |
| R7 | 1.32048E+01 | 2.39350E−05 | −2.64580E− | 1.54910E−07 | −3.74760E− | |
| R8 | 9.87027E+01 | 4.61690E−06 | −5.70060E− | 3.72960E−08 | −1.00780E− | |
| R9 | — | 1.50140E−05 | −1.67100E− | 1.05910E−07 | −2.88510E− | |
| R10 | 7.60489E+00 | 1.50370E−06 | −1.43220E− | 7.63440E−09 | −1.70910E− | |

In the Tenth Embodiment, an aspheric surface of each lens surface of the camera optical lens 100 uses a respective aspheric surface as expressed in the following condition (2).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 2 )$$

Herein, k is a conic coefficient, A4, A6, A8, A10, A12, A14, A16, A18, and A20 are aspheric surface coefficients, c is a central curvature of an optical surface, r is a vertical distance between a point on an aspheric curve and the optical axis, and z is a depth of the aspheric surface (the vertical distance between a point on the aspheric surface from which a vertical distance to the optical axis is r and a tangent plane tangent to a vertex on the optical axis of the aspheric surface).

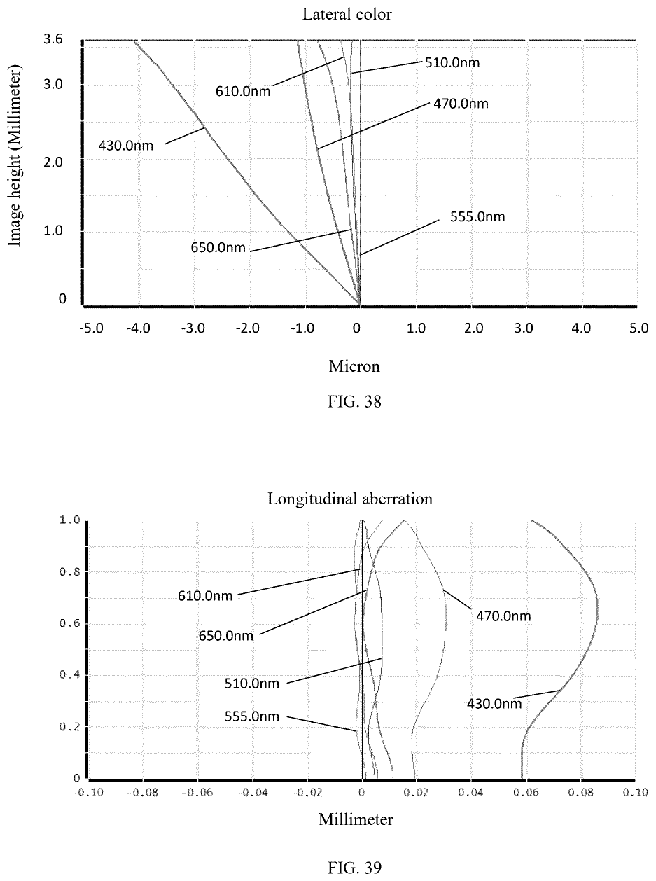

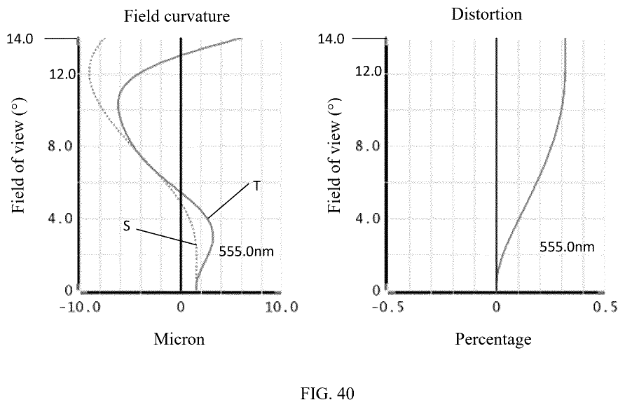

FIG. 38 and FIG. 39 schematically illustrate a lateral color and a longitudinal aberration of the camera optical lens 100 in the first state according to the Tenth Embodiment after light with wavelengths of 650 nm, 610 nm, 555 nm, 510 nm, 470 nm, and 430 nm passing through the camera optical lens 100, respectively. FIG. 40 schematically illustrates a field curvature and a distortion of the camera optical lens 100 in the first state after light with a wavelength of 555 nm passing through the camera optical lens 100 according to the Tenth Embodiment. A field curvature S in FIG. 40 is a field curvature in a sagittal direction, and Tis a field curvature in a tangential direction.

It can be derived, according to Table 37, that the Tenth Embodiment satisfies the conditions.

In the embodiment, an entrance pupil diameter (ENPD) of the camera optical lens 100 in the first state is 7.259 mm, an image height IH of 1.0H is 3.600 mm, and a diagonal field of view FOV is 28.00°. Thus, the camera optical lens 100 can meet the design requirements of long focal length, large aperture, and miniaturization, and on-axis and off-axis chromatic aberrations of the camera optical lens 100 can be completely corrected, thereby having excellent optical characteristics.

### Eleventh Embodiment

The symbols in the Eleventh Embodiment have the same meanings as those in the First Embodiment. In the following, only the differences are illustrated.

The Eleventh Embodiment differs from the First Embodiment in that in the Eleventh Embodiment, the image side surface of the first prism P1 is convex in the paraxial region, the object side surface of the third lens L3 is convex in the paraxial region, the image side surface of the fourth lens L4 is concave in the paraxial region, the object side surface of the fifth lens L5 is concave in the paraxial region, and the image side surface of the fifth lens L5 is convex in the paraxial region.

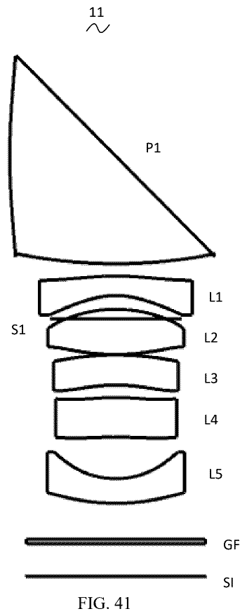

The camera optical lens 110 according to the Eleventh Embodiment is shown in FIG. 41.

Table 31 shows design data of the camera optical lens 110 according to the Eleventh Embodiment of the present disclosure.

TABLE 31

| | R | d | | nd | | vd | |
|---|---|---|---|---|---|---|---|
| S1 | ∞ | d0= | −11.950 | | | | |
| Rp1 | 27.392 | dp1= | 9.500 | nd1 | 1.8052 | vd1 | 40.91 |
| Rp2 | −22.827 | dp2= | 0.544 | | | | |
| R1 | 10.038 | d1= | 0.869 | nd2 | 1.6400 | vd2 | 23.54 |
| R2 | 3.683 | d2= | 0.594 | | | | |
| R3 | 5.579 | d3= | 2.000 | nd3 | 1.5444 | vd3 | 55.82 |
| R4 | −9.891 | d4= | d4 | | | | |
| R5 | 13.039 | d5= | 1.327 | nd4 | 1.6153 | vd4 | 25.94 |
| R6 | 7.078 | d6= | 0.549 | | | | |
| R7 | 10.204 | d7= | 1.747 | nd5 | 1.6700 | vd5 | 19.39 |
| R8 | 17.010 | d8= | 1.839 | | | | |
| R9 | −3.865 | d9= | 1.092 | nd6 | 1.5346 | vd6 | 55.69 |
| R10 | −9.719 | d10= | d10 | | | | |
| R11 | ∞ | d11= | 0.210 | ndg | 1.5168 | vdg | 64.17 |
| R12 | ∞ | d12= | 1.442 | | | | |

Herein, dp1 is a sum of “dp1-01” and “dp1-02”, a value of “dp1-01” is 5.000, and a value of “dp1-02” is 4.500.

Table 32 shows the values of the relevant optical parameters of the camera optical lens 110, in the first state and the second state respectively, in the Eleventh Embodiment of the present disclosure.

TABLE 32

| | First state | Second state |
|---|---|---|
| fA | 14.396 | 13.815 |
| FOV | 28.04° | 27.92° |
| FNO | 1.983 | 2.347 |
| d4 | 0.030 | 0.601 |
| d10 | 1.589 | 1.018 |

Table 33 shows aspherical surface data of each lens of the camera optical lens 110 in the Eleventh Embodiment of the present disclosure.

TABLE 33

| | Conic | | | | | |
|---|---|---|---|---|---|---|
| | coefficient | Aspheric surface coefficients | | | | |
| | k | A4 | A6 | A8 | A10 | A12 |
| Rp1 | — | −2.82160E− | −5.91750E− | 4.96640E−08 | 1.33320E−10 | −4.80560E− |
| Rp2 | 0.00000E+00 | 0.00000E+00 | 0.00000E+00 | 0.00000E+00 | 0.00000E+00 | 0.00000E+00 |
| R1 | 3.96063E+00 | −6.73940E− | 5.24830E−04 | −2.24740E− | −3.36610E− | 8.70660E−07 |
| R2 | −3.78628E− | −9.92730E− | 7.13320E−04 | −2.96140E− | −4.70000E− | 1.14650E−06 |
| R3 | — | 8.81390E−03 | −2.00480E− | 4.95470E−04 | −1.03150E− | 1.74030E−05 |
| R4 | 1.19630E+00 | 7.79460E−04 | −5.42730E− | 7.05770E−05 | −2.99820E− | 8.86350E−06 |
| R5 | 1.37977E+01 | −1.15900E− | 3.72280E−05 | −1.70780E− | 5.52000E−06 | −1.84590E− |
| R6 | — | 1.01530E−02 | −5.82110E− | 2.33140E−03 | −7.60120E− | 1.81400E−04 |
| R7 | 1.10077E+01 | −8.08000E− | −8.13370E− | −7.48850E− | 3.74910E−05 | −1.20740E− |
| R8 | 3.40251E+01 | −5.75060E− | −9.56290E− | 1.30110E−05 | 1.51380E−05 | −9.22140E− |
| R9 | — | −1.81890E− | 3.13530E−03 | −9.80560E− | 3.19250E−04 | −8.06830E− |
| R10 | 4.33973E+00 | 1.00340E−04 | 3.67040E−05 | 1.92320E−05 | −1.57300E− | 5.74400E−08 |
| | Conic | | | | | |
| | coefficient | Aspheric surface coefficients | | | | |
| | k | A14 | A16 | A18 | A20 | A22 |
| Rp1 | — | 9.88970E−15 | 3.61320E−14 | −9.59070E− | −1.26500E− | |
| Rp2 | 0.00000E+00 | 0.00000E+00 | 0.00000E+00 | 0.00000E+00 | 0.00000E+00 | |
| R1 | 3.96063E+00 | −1.04480E− | 7.48500E−09 | −3.03490E− | 5.33120E−12 | |
| R2 | −3.78628E− | −1.31620E− | 9.13110E−09 | −4.07000E− | 9.10430E−12 | |
| R3 | — | −2.14460E− | 1.78540E−07 | −8.86180E− | 1.97880E−10 | |
| R4 | 1.19630E+00 | −1.64870E− | 1.91060E−07 | −1.24640E− | 3.52760E−10 | |
| R5 | 1.37977E+01 | 3.30000E−07 | −2.97140E− | 9.08850E−10 | 1.36110E−11 | |
| R6 | — | −2.99160E− | 3.20980E−06 | −2.01090E− | 5.58910E−09 | |
| R7 | 1.10077E+01 | 2.57480E−06 | −3.28180E− | 2.25200E−08 | −6.50450E− | |
| R8 | 3.40251E+01 | 2.83030E−06 | −4.75640E− | 4.18600E−08 | −1.52140E− | |
| R9 | — | 1.43020E−05 | −1.61940E− | 1.03900E−07 | −2.84970E− | |
| R10 | 4.33973E+00 | −1.18590E− | 1.41930E−11 | −9.23500E− | 2.55220E−16 | |

In the Eleventh Embodiment, an aspheric surface of each lens surface of the camera optical lens 110 uses a respective aspheric surface as expressed in the following condition (2).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 2 )$$

Herein, k is a conic coefficient, A4, A6, A8, A10, A12, A14, A16, A18, and A20 are aspheric surface coefficients, c is a central curvature of an optical surface, r is a vertical distance between a point on an aspheric curve and the optical axis, and z is a depth of the aspheric surface (the vertical distance between a point on the aspheric surface from which a vertical distance to the optical axis is r and a tangent plane tangent to a vertex on the optical axis of the aspheric surface).

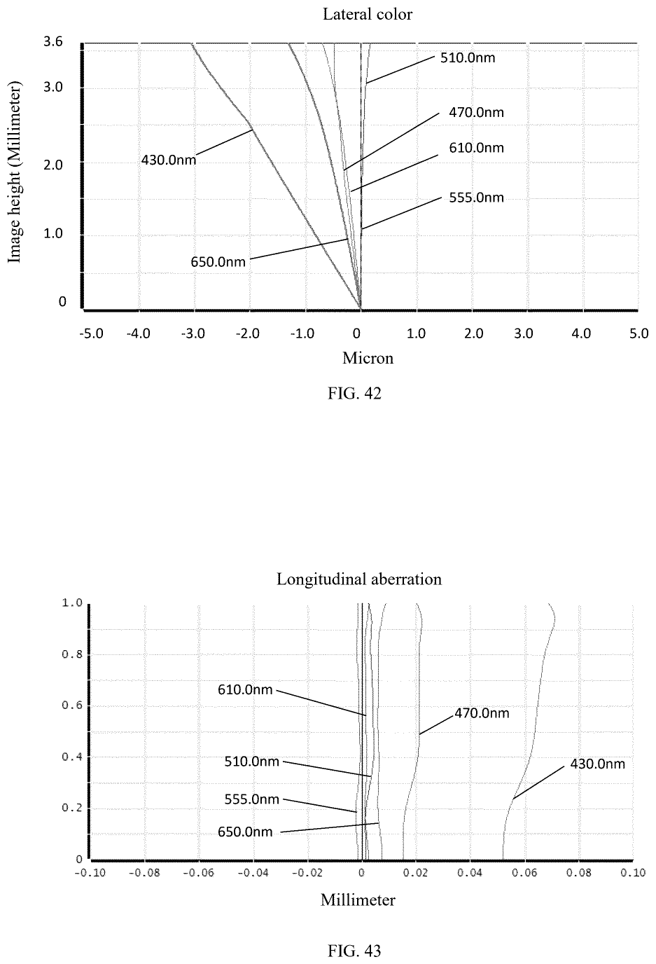

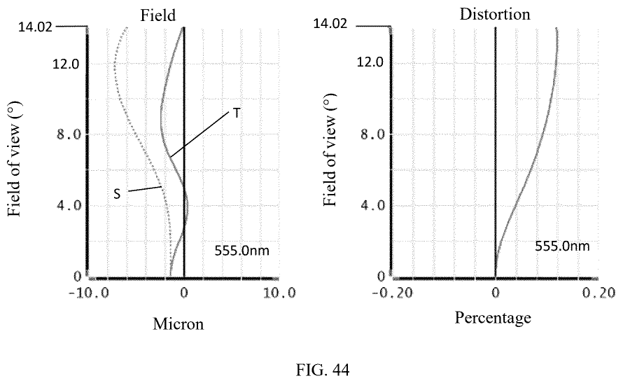

FIG. 42 and FIG. 43 schematically illustrate a lateral color and a longitudinal aberration of the camera optical lens 110 in the first state according to the Eleventh Embodiment after light with wavelengths of 650 nm, 610 nm, 555 nm, 510 nm, 470 nm, and 430 nm passing through the camera optical lens 110, respectively. FIG. 44 schematically illustrates a field curvature and a distortion of the camera optical lens 110 in the first state after light with a wavelength of 555 nm passing through the camera optical lens 110 according to the Eleventh Embodiment. A field curvature S in FIG. 44 is a field curvature in a sagittal direction, and Tis a field curvature in a tangential direction.

It can be derived, according to Table 37, that the Eleventh Embodiment satisfies the conditions.

In the embodiment, an entrance pupil diameter (ENPD) of the camera optical lens 110 in the first state is 7.259 mm, an image height IH of 1.0H is 3.600 mm, and a diagonal field of view FOV is 28.04°. Thus, the camera optical lens 110 can meet the design requirements of long focal length, large aperture, and miniaturization, and on-axis and off-axis chromatic aberrations of the camera optical lens 110 can be completely corrected, thereby having excellent optical characteristics.

### Twelfth Embodiment

The symbols in the Twelfth Embodiment have the same meanings as those in the First Embodiment. In the following, only the differences are illustrated.

The Twelfth Embodiment differs from the First Embodiment in that in the Twelfth Embodiment, the image side surface of the first prism P1 is convex in the paraxial region, the object side surface of the third lens L3 is convex in the paraxial region, the image side surface of the fourth lens L4 is concave in the paraxial region, the object side surface of the fifth lens L5 is concave in the paraxial region, and the image side surface of the fifth lens L5 is convex in the paraxial region.

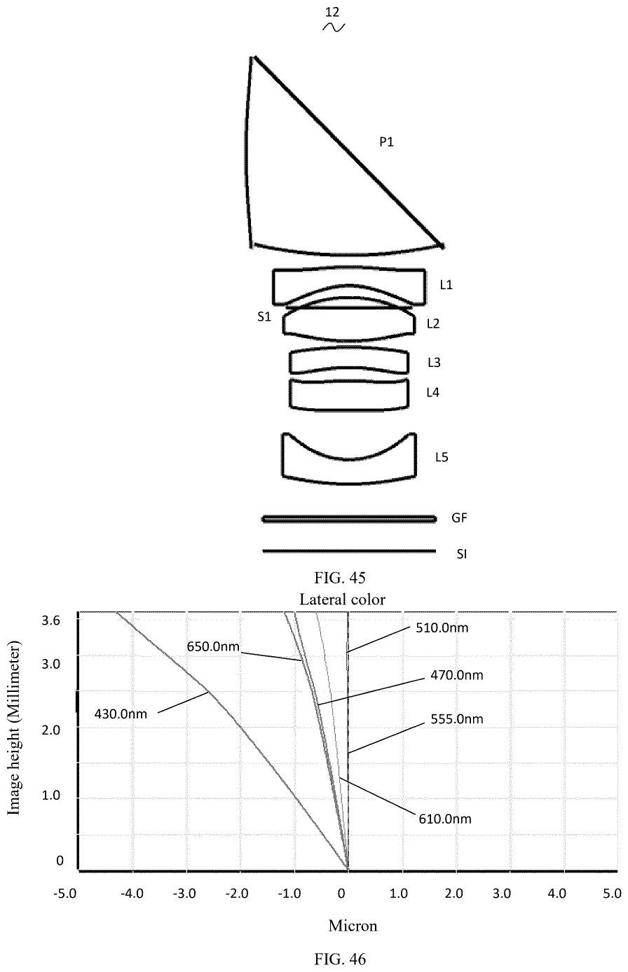

The camera optical lens 120 according to the Twelfth Embodiment is shown in FIG. 45.

Table 34 shows design data of the camera optical lens 120 according to the Twelfth Embodiment of the present disclosure.

TABLE 34

| | R | d | | nd | | vd | |
|---|---|---|---|---|---|---|---|
| S1 | ∞ | d0= | −11.897 | | | | |
| Rp1 | 27.895 | dp1= | 9.500 | nd1 | 1.8052 | vd1 | 40.91 |
| Rp2 | −19.925 | dp2= | 0.545 | | | | |
| R1 | 10.804 | d1= | 0.852 | nd2 | 1.6400 | vd2 | 23.54 |
| R2 | 3.680 | d2= | 0.542 | | | | |
| R3 | 5.586 | d3= | 2.000 | nd3 | 1.5444 | vd3 | 55.82 |
| R4 | −9.377 | d4= | d4 | | | | |
| R5 | 14.020 | d5= | 0.927 | nd4 | 1.6153 | vd4 | 25.94 |
| R6 | 6.823 | d6= | 0.612 | | | | |
| R7 | 10.837 | d7= | 1.348 | nd5 | 1.6700 | vd5 | 19.39 |
| R8 | 34.921 | d8= | 2.270 | | | | |
| R9 | −3.786 | d9= | 1.124 | nd6 | 1.5346 | vd6 | 55.69 |
| R10 | −11.880 | d10= | d10 | | | | |
| R11 | ∞ | d11= | 0.210 | ndg | 1.5168 | vdg | 64.17 |
| R12 | ∞ | d12= | 1.386 | | | | |

Herein, dp1 is a sum of “dp1-01” and “dp1-02”, a value of “dp1-01” is 5.000, and a value of “dp1-02” is 4.500.

Table 35 shows the values of the relevant optical parameters of the camera optical lens 120, in the first state and the second state respectively, in the Twelfth Embodiment of the present disclosure.

TABLE 35

| | First state | Second state |
|---|---|---|
| fA | 14.396 | 13.830 |
| FOV | 28.05° | 27.95° |
| FNO | 1.983 | 2.296 |
| d4 | 0.276 | 0.803 |
| d10 | 1.488 | 0.961 |

Table 36 shows aspherical surface data of each lens of the camera optical lens 120 in the Twelfth Embodiment of the present disclosure.

TABLE 36

| | Conic | | | | | |
|---|---|---|---|---|---|---|
| | coefficient | Aspheric surface coefficients | | | | |
| | k | A4 | A6 | A8 | A10 | A12 |
| Rp1 | — | −3.37860E− | −6.03350E− | 4.90140E−08 | 2.37680E−10 | −4.68400E− |
| Rp2 | 0.00000E+00 | 0.00000E+00 | 0.00000E+00 | 0.00000E+00 | 0.00000E+00 | 0.00000E+00 |
| R1 | 3.91070E+00 | −6.81100E− | 5.20310E−04 | −1.81460E− | −3.89630E− | 8.34500E−07 |
| R2 | −3.81432E− | −9.64410E− | 6.47740E−04 | −2.45960E− | −9.82280E− | −5.56450E− |
| R3 | — | 8.70390E−03 | −1.87060E− | 4.38560E−04 | −8.57470E− | 1.38030E−05 |
| R4 | 1.21309E+00 | 7.17630E−04 | −2.19820E− | 4.91320E−05 | −2.00130E− | 6.06960E−06 |
| R5 | 1.40296E+01 | −1.53370E− | 2.04150E−04 | −8.58730E− | 3.89590E−05 | −1.33630E− |
| R6 | — | 1.02300E−02 | −5.61950E− | 2.24970E−03 | −7.29880E− | 1.72140E−04 |
| R7 | 9.97064E+00 | −8.35900E− | −3.02740E− | −8.63340E− | 4.93210E−05 | −1.80200E− |
| R8 | 3.29016E+01 | −5.66200E− | −1.58480E− | 1.03310E−04 | −4.03300E− | 1.26070E−05 |
| R9 | — | −1.89950E− | 3.60720E−03 | −9.05530E− | 2.09020E−04 | −3.61760E− |
| R10 | 7.18960E+00 | 4.69920E−04 | 4.46870E−05 | 1.25450E−05 | −1.13890E− | 4.43320E−08 |
| | Conic | | | | | |
| | coefficient | Aspheric surface coefficients | | | | |
| | k | A14 | A16 | A18 | A20 | A22 |
| Rp1 | — | −5.54140E− | 3.45760E−14 | 5.30140E−17 | −1.57450E− | |
| Rp2 | 0.00000E+00 | 0.00000E+00 | 0.00000E+00 | 0.00000E+00 | 0.00000E+00 | |
| R1 | 3.91070E+00 | −8.63640E− | 5.27040E−09 | −1.79620E− | 2.66610E−12 | |
| R2 | −3.81432E− | 2.12440E−07 | −3.01190E− | 1.95610E−09 | −4.78250E− | |
| R3 | — | −1.66010E− | 1.38230E−07 | −7.08700E− | 1.69890E−10 | |
| R4 | 1.21309E+00 | −1.16470E− | 1.41720E−07 | −9.85790E− | 3.01510E−10 | |
| R5 | 1.40296E+01 | 2.86460E−06 | −3.66990E− | 2.56210E−08 | −7.55740E− | |
| R6 | — | −2.79690E− | 2.94520E−06 | −1.79920E− | 4.76670E−09 | |
| R7 | 9.97064E+00 | 4.24410E−06 | −5.93620E− | 4.64370E−08 | −1.67070E− | |
| R8 | 3.29016E+01 | −2.44170E− | 2.92000E−07 | −1.95460E− | 5.41320E−10 | |
| R9 | — | 4.39680E−06 | −3.46730E− | 1.55210E−08 | −2.98820E− | |

| | | | | | |
|---|---|---|---|---|---|
| R10 | 7.18960E+00 | −9.76790E− | 1.24770E−11 | −8.71220E− | 2.62320E−16 |

In the Twelfth Embodiment, an aspheric surface of each lens surface of the camera optical lens 120 uses a respective aspheric surface as expressed in the following condition (2).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 2 )$$

Herein, k is a conic coefficient, A4, A6, A8, A10, A12, A14, A16, A18, and A20 are aspheric surface coefficients, c is a central curvature of an optical surface, r is a vertical distance between a point on an aspheric curve and the optical axis, and z is a depth of the aspheric surface (the vertical distance between a point on the aspheric surface from which a vertical distance to the optical axis is r and a tangent plane tangent to a vertex on the optical axis of the aspheric surface).

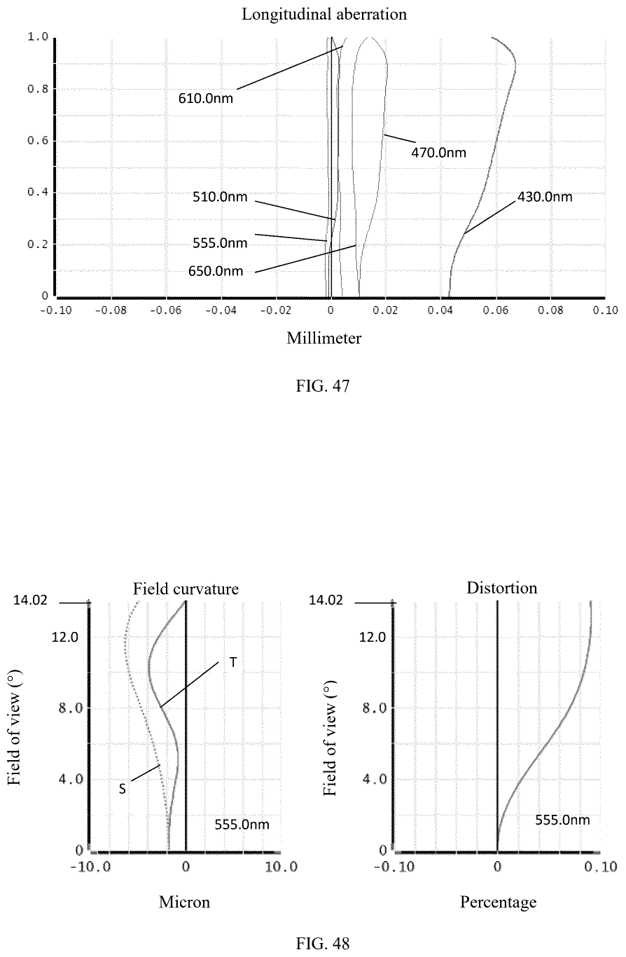

FIG. 46 and FIG. 47 schematically illustrate a lateral color and a longitudinal aberration of the camera optical lens 120 in the first state according to the Twelfth Embodiment after light with wavelengths of 650 nm, 610 nm, 555 nm, 510 nm, 470 nm, and 430 nm passing through the camera optical lens 120, respectively. FIG. 48 schematically illustrates a field curvature and a distortion of the camera optical lens 120 in the first state after light with a wavelength of 555 nm passing through the camera optical lens 120 according to the Twelfth Embodiment. A field curvature S in FIG. 48 is a field curvature in a sagittal direction, and Tis a field curvature in a tangential direction.

It can be derived, according to Table 37, that the Twelfth Embodiment satisfies the conditions.

In the embodiment, an entrance pupil diameter (ENPD) of the camera optical lens 120 in the first state is 7.259 mm, an image height IH of 1.0H is 3.600 mm, and a diagonal field of view FOV is 28.05°. Thus, the camera optical lens 120 can meet the design requirements of long focal length, large aperture, and miniaturization, and on-axis and off-axis chromatic aberrations of the camera optical lens 120 can be completely corrected, thereby having excellent optical characteristics.

TABLE 37

| Parameters and | First | Second | Third | Fourth |
|---|---|---|---|---|
| Conditions | Embodiment | Embodiment | Embodiment | Embodiment |
| fA/IH | 4.42 | 4.420 | 4.59 | 4.00 |
| Rp1/Rp2 | 0.69 | 0.00 | 0.30 | −7.11E+19 |
| (R1 + R2)/ | 5.76 | 4.41 | 4.94 | 3.12 |
| (R1 − R2) | | | | |
| d5/d7 | 1.00 | 0.62 | 0.40 | 1.74 |
| d1/d3 | 0.97 | 0.79 | 0.66 | 0.86 |
| fA | 15.911 | 15.912 | 16.540 | 14.396 |
| fp1 | 59.245 | 36.032 | 38.421 | 19.122 |
| f1 | −32.117 | −22.013 | −23.413 | −14.536 |
| f2 | 5.498 | 5.63 | 5.598 | 6.227 |
| f3 | −7.400 | −7.525 | −7.848 | −9.018 |
| f4 | 22.339 | 24.350 | 18.747 | 97.100 |
| f5 | −65.030 | −131.028 | −18.771 | −63070.138 |
| FNO | 2.318 | 2.319 | 2.318 | 1.983 |
| TTL | 28.268 | 28.124 | 27.933 | 27.009 |
| IH | 3.600 | 3.600 | 3.600 | 3.600 |
| FOV | 25.00° | 25.00° | 24.56° | 27.99° |
| Parameters and | Fifth | Sixth | Seventh | Eighth |
| [symbol] | Embodiment | Embodiment | Embodiment | Embodiment |
| fA/IH | 4.60 | 4.08 | 4.02 | 4.00 |
| Rp1/Rp2 | 0.70 | 0.80 | 0.00 | −1.195 |
| (R1 + R2)/ | 4.36 | 4.18 | 2.96 | 1.87 |
| (R1 − R2) | | | | |
| d5/d7 | 1.18 | 0.97 | 1.67 | 1.29 |
| d1/d3 | 0.75 | 0.85 | 0.27 | 0.47 |
| fA | 16.560 | 14.689 | 14.472 | 14.396 |
| fp1 | 54.177 | 151.390 | 26.379 | 16.263 |
| f1 | −19.991 | −18.590 | −11.195 | −9.216 |
| f2 | 5.343 | 5.052 | 6.406 | 6.644 |
| f3 | −8.065 | −8.065 | −32.289 | −20.915 |
| f4 | 16.323 | 30.077 | 37.774 | 23.594 |
| f5 | −24.639 | 947.839 | −11.112 | −10.725 |
| FNO | 2.318 | 2.318 | 1.983 | 1.983 |
| TTL | 25.576 | 29.682 | 22.576 | 23.551 |
| IH | 3.600 | 3.600 | 3.600 | 3.600 |
| FOV | 24.31° | 26.99° | 27.60° | 28.05° |
| Parameters and | Ninth | Tenth | Eleventh | Twelfth |
| [symbol] | Embodiment | Embodiment | Embodiment | Embodiment |
| fA/IH | 4.00 | 4.00 | 4.00 | 4.00 |
| Rp1/Rp2 | −0.738 | −4.00 | −1.20 | −1.40 |
| (R1 + R2)/ | 2.16 | 1.48 | 2.16 | 2.03 |
| (R1 − R2) | | | | |
| d5/d7 | 0.57 | 0.16 | 0.76 | 0.69 |
| d1/d3 | 0.38 | 0.87 | 0.43 | 0.43 |
| fA | 14.396 | 14.396 | 14.396 | 14.396 |
| fp1 | 18.305 | 14.581 | 16.816 | 15.771 |
| f1 | −9.703 | −9.066 | −9.533 | −9.081 |
| f2 | 6.522 | 6.997 | 6.843 | 6.727 |
| f3 | −20.890 | −21.214 | −27.312 | −22.568 |
| f4 | 23.693 | 28.436 | 34.178 | 22.726 |
| f5 | −10.532 | −12.562 | −12.797 | −10.888 |
| FNO | 1.983 | 1.983 | 1.983 | 1.983 |
| TTL | 22.773 | 25.283 | 23.332 | 23.080 |
| IH | 3.600 | 3.600 | 3.600 | 3.600 |
| FOV | 28.05° | 28.00° | 28.04° | 28.05° |

[symbol]

indicates data missing or illegible when filed

Those skilled in the art shall understand that the embodiments described above are specific embodiments for implementing the present disclosure. In practice, various changes may be made to these embodiments in form and in detail without departing from the spirit and scope of the disclosure.

What is claimed is:

1. A camera optical lens, comprising, from an object side to an image side in sequence, a first prism with a positive refractive power, a first lens with a negative refractive power, a second lens with a positive refractive power, a third lens with a negative refractive power, a fourth lens with a positive refractive power, and a fifth lens;
wherein the first lens and the second lens form a first group, and the third lens, the fourth lens, and the fifth lens form a second group that is movable and adjustable along an optical axis of the camera optical lens, allowing the camera optical lens switchable between a first state and a second state, and wherein the camera optical lens has a maximum focal length in the first state and has a minimum focal length in the second state;
wherein a reflective surface is provided between an object side surface of the first prism and an image side surface of the first prism; and
wherein the camera optical lens satisfies the following conditions:
$$3.99 \leq fA / IH \leq 4.8 ;$$
$$Rp 1 / Rp 2 \leq 0.8 ;$$
$$1.4 \leq ( R 1 + R 2 ) / ( R 1 - R 2 ) \leq 5.8 ; and$$
$$0.16 \leq d 5 / d 7 \leq 1.8 ;$$
wherein fA represents a focal length of the camera optical lens in the first state;
IH represents an image height of 1.0H of the camera optical lens;
Rp1 represents a curvature radius of the object side surface of the first prism;
Rp2 represents a curvature radius of the image side surface of the first prism;
R1 represents a curvature radius of an object side surface of the first lens;
R2 represents a curvature radius of an image side surface of the first lens;
d5 represents an on-axis thickness of the third lens; and
d7 represents an on-axis thickness of the fourth lens.

2. The camera optical lens according to claim 1, further satisfies the following condition:
$$3.99 \leq fA / IH \leq 4.6 .$$

3. The camera optical lens according to claim 1, further satisfies the following condition:
0.25≤d1/d3≤1.00; wherein
d1 represents an on-axis thickness of the first lens; and
d3 represents an on-axis thickness of the second lens.

4. The camera optical lens according to claim 1, further satisfies the following conditions:
$$1.01 \leq fp 1 / fA \leq 10.31 ; and$$
$$0.32 \leq dp 1 / TTL \leq 0.421 ;$$
wherein
fp1 represents a focal length of the first prism;
dp1 represents a sum of an on-axis distance between the object side surface of the first prism and the reflective surface and an on-axis distance between the reflective surface and the image side surface of the first prism; and
TTL represents a total track length of the camera optical lens.

5. The camera optical lens according to claim 1, wherein an object side surface of the first lens is convex in a paraxial region, and an image side surface of the first lens is concave in the paraxial region;
wherein the camera optical lens further satisfies the following conditions:
$$- 2.02 \leq f 1 / fA \leq - 0.62 ; and$$
$$0.024 \leq d 1 / TTL \leq 0.069 ;$$
wherein
f1 represents a focal length of the first lens;
d1 represents an on-axis thickness of the first lens; and
TTL represents a total track length of the camera optical lens.

6. The camera optical lens according to claim 1, wherein an object side surface of the second lens is convex in a paraxial region, and an image side surface of the second lens is concave in the paraxial region;
wherein the camera optical lens further satisfies the following conditions:
$$0.32 \leq f 2 / fA \leq 0.49 ;$$
$$- 0.28 \leq ( R 3 + R 4 ) / ( R 3 - R 4 ) \leq 0.03 ; and$$
$$0.056 \leq d 3 / TTL \leq 0.089 ;$$
wherein
f2 represents a focal length of the second lens;
R3 represents a curvature radius of the object side surface of the second lens;
R4 represents a curvature radius of the image side surface of the second lens;
d3 represents an on-axis thickness of the second lens; and
TTL represents a total track length of the camera optical lens.

7. The camera optical lens according to claim 1, wherein an image side surface of the third lens is concave in a paraxial region, and the camera optical lens further satisfies the following conditions:
$$- 2.24 \leq f 3 / fA \leq - 0.46 ;$$
$$- 0.68 \leq ( R 5 + R 6 ) / ( R 5 - R 6 ) \leq 3.38 ; and$$
$$0.011 \leq d 5 / TTL \leq 0.079 ;$$
wherein
f3 represents a focal length of the third lens; and
R5 represents a curvature radius of the object side surface of the third lens;
R6 represents a curvature radius of an image side surface of the third lens; and
TTL represents a total track length of the camera optical lens.

8. The camera optical lens according to claim 1, further satisfies the following conditions:
$$0.98 \leq f 4 / fA \leq 6.75 ;$$
$$- 4. \leq ( R 7 + R 8 ) / ( R 7 - R 8 ) \leq 18.99 ; and$$
$$0.037 \leq d 7 / TTL \leq 0.075 ;$$
wherein
f4 represents a focal length of the fourth lens;
R7 represents a curvature radius of the object side surface of the fourth lens;
R8 represents a curvature radius of an image side surface of the fourth lens; and
TTL represents a total track length of the camera optical lens.

9. The camera optical lens according to claim 1, further satisfies the following conditions:
$$- 4381.09 \leq f 5 / fA \leq 64.53 ;$$
$$- 60.05 \leq ( R 9 + R 10 ) / ( R 9 - R 10 ) \leq 15.6 ; and$$
$$0.018 \leq d 9 / TTL \leq 0.088 ;$$
wherein
f5 represents a focal length of the fifth lens;
R9 represents a curvature radius of the object side surface of the fifth lens;
R10 represents a curvature radius of an image side surface of the fifth lens;
d9 represents an on-axis thickness of the fifth lens; and
TTL represents a total track length of the camera optical lens.

10. The camera optical lens according to claim 1, wherein the first prism is made of glass.
